(19) United States
(12) Patent Application Publication
(10) Pub. No.: US 2026/0333365 A1
(43) Pub. Date: Oct. 22, 2026

(54) POWER RAMPING COUNTER PROCESSING METHOD AND APPARATUS, COMMAND SENDING METHOD AND APPARATUS, AND DEVICE

(71) Applicant: VIVO MOBILE COMMUNICATION CO., LTD., Dongguan (CN)

(72) Inventors: Yangyang WANG, Dongguan (CN); Chenxi WANG, Dongguan (CN)

(73) Assignee: VIVO MOBILE COMMUNICATION CO., LTD., Dongguan (CN)

(21) Appl. No.: 19/463,863

(22) Filed: Jan. 29, 2026

Related U.S. Application Data
(63) Continuation of application No. PCT/CN2024/108360, filed on Jul. 30, 2024.

(30) Foreign Application Priority Data
Aug. 2, 2023 (CN) 202310966305.7
Sep. 22, 2023 (CN) 202311232736.7

(51) Int. Cl. H04W 72/23; H04W 56/00; H04W 74/0833

(52) U.S. Cl. CPC H04W 72/23; H04W 56/0045; H04W 74/0833

(57) ABSTRACT

This application discloses a power ramping counter processing method and apparatus, a command sending method and apparatus, and a device. The power ramping counter processing method according to an embodiment of this application includes: receiving, by a terminal, a target PDCCH order, where the target PDCCH order is used to trigger the terminal to execute an early TA acquisition procedure of a target candidate cell; and performing, by the terminal, a first operation, where the first operation includes at least one of the following: in a case that the terminal maintains a plurality of preamble received target power ramping counters, resetting or incrementing by 1, based on the target PDCCH order, a preamble received target power ramping counter associated with the target candidate cell; and resetting or incrementing by 1, based on target information, a preamble received target power ramping counter.

### CROSS-REFERENCE TO RELATED APPLICATIONS

This application is a continuation application of PCT International Application No. PCT/CN2024/108360 filed on Jul. 30, 2024, which claims priority to Chinese Patent Application No. 202311232736.7, filed with the China National Intellectual Property Administration on Sep. 22, 2023, which is incorporated herein by reference in its entirety. This application also claims priority to Chinese Patent Application No. 202310966305.7, filed with the China National Intellectual Property Administration on Aug. 2, 2023.

### TECHNICAL FIELD

This application pertains to the field of communication technology, and specifically, relates to a power ramping counter processing method and apparatus, a command sending method and apparatus, and a device.

### BACKGROUND

In a random access procedure, a target received power of a preamble is calculated based on a preamble received target power ramping counter (which may also be referred to as a preamble power ramping counter for short). In some related technologies, the terminal maintains only one preamble received target power ramping counter, merely resetting or incrementing the counter by 1 based on new transmission or retransmission indicated by a physical downlink control channel (PDCCH) command, where the PDCCH order is specifically used to trigger a terminal to execute an early timing advance (TA) acquisition procedure of a candidate cell. However, the above solution may lead to poor transmitting performance when the terminal transmits the preamble.

### SUMMARY

Embodiments of this application provide a power ramping counter processing method and apparatus, a command sending method and apparatus, and a device.

According to a first aspect, a power ramping counter processing method is provided, including:
receiving, by a terminal, a target PDCCH order, where the target PDCCH order is used to trigger the terminal to execute an early TA acquisition procedure of a target candidate cell; and
performing, by the terminal, a first operation, where the first operation includes at least one of the following:
in a case that the terminal maintains a plurality of preamble received target power ramping counters, resetting or incrementing by 1, based on the target PDCCH order, a preamble received target power ramping counter associated with the target candidate cell; and
resetting or incrementing by 1, based on target information, a preamble received target power ramping counter, where the target information includes at least one of the following:
an association relationship between the target PDCCH order and another PDCCH order;
association information of the another PDCCH order;
detection information associated with the target PDCCH order; and
an association relationship between the early TA acquisition procedure of the target candidate cell and a last random access procedure; where
the another PDCCH order includes a PDCCH order received before the target PDCCH order is received; and
the last random access procedure is a latest random access procedure executed before the early TA acquisition procedure of the target candidate cell, triggered by the target PDCCH order, is executed.

According to a second aspect, a command sending method is provided, including:
sending, by a network-side device, a first PDCCH order to a terminal, where the first PDCCH order is used to trigger execution of an early TA acquisition procedure of a first candidate cell and indicate a new transmission; and
sending, by the network-side device, a second PDCCH order to the terminal under a target condition, where the second PDCCH order is used to trigger execution of an early TA acquisition procedure of a second candidate cell; and
the target condition includes any one of the following:
the network-side device confirms that the early TA acquisition procedure of the first candidate cell is completed successfully, or the network-side device confirms that the early TA acquisition procedure of the first candidate cell is not completed successfully;
the network-side device successfully sends the first PDCCH order; and
the network-side device successfully triggers the terminal to execute the early TA acquisition procedure of the first candidate cell.

According to a third aspect, a power ramping counter processing apparatus is provided, including:
a receiving module configured to receive a target PDCCH order, where the target PDCCH order is used to trigger a terminal to execute an early TA acquisition procedure of a target candidate cell; and
an execution module configured to perform a first operation, where the first operation includes at least one of the following:
in a case that the terminal maintains a plurality of preamble received target power ramping counters, resetting or incrementing by 1, based on the target PDCCH order, a preamble received target power ramping counter associated with the target candidate cell; and
resetting or incrementing by 1, based on target information, a preamble received target power ramping counter, where the target information includes at least one of the following:
an association relationship between the target PDCCH order and another PDCCH order;
association information of the another PDCCH order;
detection information associated with the target PDCCH order; and
an association relationship between the early TA acquisition procedure of the target candidate cell and a last random access procedure; where
the another PDCCH order includes a PDCCH order received before the target PDCCH order is received; and the last random access procedure is a latest random access procedure executed before the early TA acquisition procedure of the target candidate cell, triggered by the target PDCCH order, is executed.

According to a fourth aspect, a command sending apparatus is provided, including:
a first sending module configured to send a first physical downlink control channel PDCCH order to a terminal, where the first PDCCH order is used to trigger execution of an early TA acquisition procedure of a first candidate cell and indicate a new transmission; and
a second sending module configured to send a second PDCCH order to the terminal under a target condition, where the second PDCCH order is used to trigger execution of an early TA acquisition procedure of a second candidate cell; and
the target condition includes any one of the following:
a network-side device confirms that the early TA acquisition procedure of the first candidate cell is completed successfully, or the network-side device confirms that the early TA acquisition procedure of the first candidate cell is not completed successfully;
the network-side device successfully sends the first PDCCH order; and
the network-side device successfully triggers the terminal to execute the early TA acquisition procedure of the first candidate cell.

According to a fifth aspect, a terminal is provided. The terminal includes a processor and a memory, where the memory stores a program or instructions capable of running on the processor, and when the program or instructions are executed by the processor, steps of the power ramping counter processing method according to the embodiments of this application are implemented.

According to a sixth aspect, a terminal is provided, including a processor and a communication interface. The communication interface is configured to receive a target PDCCH order, where the target PDCCH order is used to trigger the terminal to execute an early TA acquisition procedure of a target candidate cell. The processor is configured to perform a first operation, where the first operation includes at least one of the following: in a case that the terminal maintains a plurality of preamble received target power ramping counters, resetting or incrementing by 1, based on the target PDCCH order, a preamble received target power ramping counter associated with the target candidate cell; and resetting or incrementing by 1, based on target information, a preamble received target power ramping counter, where the target information includes at least one of the following: an association relationship between the target PDCCH order and another PDCCH order; association information of the another PDCCH order; detection information associated with the target PDCCH order; and an association relationship between the early TA acquisition procedure of the target candidate cell and a last random access procedure; where the another PDCCH order includes a PDCCH order received before the target PDCCH order is received; and the last random access procedure is a latest random access procedure executed before the early TA acquisition procedure of the target candidate cell, triggered by the target PDCCH order, is executed.

According to a seventh aspect, a network-side device is provided. The network-side device includes a processor and a memory, where the memory stores a program or instructions capable of running on the processor, and when the program or instructions are executed by the processor, steps of the command sending method according to the embodiments of this application are implemented.

According to an eighth aspect, a network-side device is provided, including a processor and a communication interface. The communication interface is configured to: send a first physical downlink control channel PDCCH order to a terminal, where the first PDCCH order is used to trigger execution of an early TA acquisition procedure of a first candidate cell and indicate a new transmission; and send a second PDCCH order to the terminal under a target condition, where the second PDCCH order is used to trigger execution of an early TA acquisition procedure of a second candidate cell; and the target condition includes any one of the following: the network-side device confirms that the early TA acquisition procedure of the first candidate cell is completed successfully, or the network-side device confirms that the early TA acquisition procedure of the first candidate cell is not completed successfully; the network-side device successfully sends the first PDCCH order; and the network-side device successfully triggers the terminal to execute the early TA acquisition procedure of the first candidate cell.

According to a ninth aspect, a readable storage medium is provided, where the readable storage medium stores a program or instructions, and when the program or instructions are executed by a processor, steps of the power ramping counter processing method according to the embodiments of this application are implemented, or steps of the command sending method according to the embodiments of this application are implemented.

According to a tenth aspect, a wireless communication system is provided, including: a terminal and a network-side device, where the terminal may be configured to perform the steps of the power ramping counter processing method according to the embodiments of this application, and the network-side device may be configured to perform the steps of the command sending method according to the embodiments of this application.

According to an eleventh aspect, a chip is provided, where the chip includes a processor and a communication interface, the communication interface is coupled to the processor, and the processor is configured to run a program or instructions to implement the power ramping counter processing method according to the embodiments of this application, or implement the command sending method according to the embodiments of this application.

According to a twelfth aspect, a computer program/program product is provided, where the computer program/program product is stored in a storage medium, and the program/program product is executed by at least one processor to implement steps of the power ramping counter processing method according to the embodiments of this application, or the program/program product is executed by at least one processor to implement steps of the command sending method according to the embodiments of this application.

### BRIEF DESCRIPTION OF DRAWINGS

FIG. 1 is a block diagram of a wireless communication system to which embodiments of this application are applicable;

FIG. 2 is a flowchart of a power ramping counter processing method according to an embodiment of this application;

FIG. 3 is a flowchart of a command sending method according to an embodiment of this application;

FIG. 4 is a schematic diagram of processing of a power ramping counter according to an embodiment of this application;

FIG. 5 is another schematic diagram of processing of a power ramping counter according to an embodiment of this application;

FIG. 6 is a structural diagram of a power ramping counter processing apparatus according to an embodiment of this application;

FIG. 7 is a structural diagram of a command sending apparatus according to an embodiment of this application;

FIG. 8 is a structural diagram of a communication device according to an embodiment of this application;

FIG. 9 is a structural diagram of a terminal according to an embodiment of this application; and

FIG. 10 is a structural diagram of a network-side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or more first objects. In addition, “or” in this application indicates at least one of the connected objects. For example, “A or B” covers three cases: including A but not B; including B but not A; and including both A and B. The character “/” generally indicates that the associated objects before and after it are in an “or” relationship.

The term “indication” in this application can be either a direct indication (or explicit indication) or an indirect indication (or implicit indication). Direct indication can be understood as the sender explicitly informing the receiver of content such as specific information, operations to be performed, or requested results in the sent indication. Indirect indication can be understood as the receiver determining corresponding information based on the indication sent by the sender, or making judgments and determining operations to be performed, requested results, or the like based on the judgment results.

It should be noted that technologies described in the embodiments of this application are not limited to a long term evolution (LTE)/LTE-advanced (LTE-A) system, and may also be applied to other wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” are often used interchangeably in the embodiments of this application. The technologies described may be used in the above-mentioned systems and radio technologies as well as other systems and radio technologies. In the following descriptions, a new radio (NR) system is described for illustration purpose, and NR terms are used in most of the following descriptions, although these technologies may also be applied to other applications than an NR system application, for example, the 6th generation (6G) communication system.

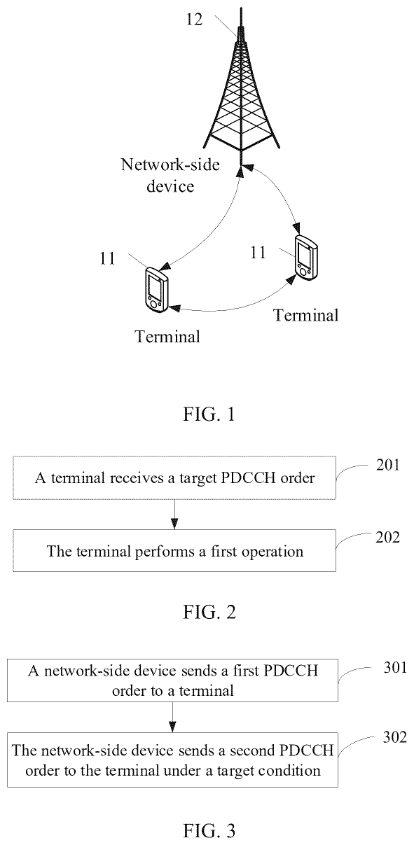

FIG. 1 is a block diagram of a wireless communication system to which the embodiments of this application are applicable. The wireless communication system includes a terminal 11 and a network-side device 12. The terminal 11 may be a terminal-side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR) or virtual reality (VR) device, a robot, a wearable device, a flight vehicle, vehicle user equipment (VUE), ship-borne equipment, pedestrian user equipment (PUE), smart household (home devices with wireless communication functions, such as refrigerators, televisions, washing machines, or furniture), a game console, a personal computer (PC), a teller machine, or a self-service machine. The wearable device includes a smartwatch, a smart band, smart earphones, smart glasses, smart jewelry (a smart bracelet, a smart band, a smart ring, a smart necklace, a smart leglet, a smart anklet, and the like), a smart wristband, smart clothing, or the like. The vehicle user equipment may also be referred to as an in-vehicle terminal, an in-vehicle controller, an in-vehicle module, an in-vehicle component, an in-vehicle chip, an in-vehicle unit, or the like. It should be noted that the terminal 11 is not limited to a specific type in the embodiments of this application.

The network-side device 12 may include an access network device or a core network device. The access network device may also be referred to as a radio access network (RAN), a wireless access network function, or a wireless access network unit. The access network device may include a base station, a wireless local area network (WLAN) access point (AP), a wireless fidelity (Wi-Fi) node, or the like. The base station may be referred to as a NodeB (NB), an evolved NodeB (eNB), a next generation NodeB, a new radio NodeB (NR Node B), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or other suitable terms in the field. Provided that the same technical effect is achieved, the base station is not limited to specific technical terms. It should be noted that in the embodiments of this application, only the base station in the NR system is used as an example for description, but the specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), and an application function (AF). It should be noted that in the embodiments of this application, only the core network device in the NR system is used as an example for description, but the specific type of the core network device is not limited.

In some embodiments, in a random access procedure, in order to ensure successful transmission of a preamble, after each preamble transmission fails, or no random access response (RAR) is received, or contention resolution fails, the terminal retransmits the preamble. If a reference signal selected by the terminal during the current random access is the same as a reference signal selected during the last unsuccessful random access procedure, the terminal increments a power ramping counter. For example, if a synchronization signal block (SSB) or a channel state information reference signal (CSI-RS) is the same as an SSB or a CSI-RS selected during the last unsuccessful random access procedure, the terminal increments the power ramping counter. Incrementing the power ramping counter allows for calculation of a larger target received power of the preamble, increasing the probability of successful preamble transmission. Specifically, the counter is called a preamble received target power ramping counter, or a preamble power ramping counter.

In some embodiments, the target received power (PREAMBLE_RECEIVED_TARGET_POWER) of the preamble is calculated according to the following formula:

preambleReceivedTargetPower+DELTA_PREAMBLE+(PREAMBLE_POWER_RAMPING_COUNTER−1)×PREAMBLE_POWER_RAMPING_STEP;
where: preambleReceivedTargetPower is an initial power at which the network-side device expects to receive the preamble;
DELTA_PREAMBLE represents an offset based on a preamble format, which is specifically related to the preamble format, and a value of DELTA_PREAMBLE is specified in a protocol;
PREAMBLE_POWER_RAMPING_STEP represents a power increase for a next random access when the random access fails but the current random access is not completed; and

PREAMBLE_POWER_RAMPING_COUNTER represents a power ramping counter, that is, the preamble received target power ramping counter, where this counter is reset to 1 each time the terminal starts a new random access procedure.

It should be noted that in the embodiments of this application, the implementation of calculating the target received power of the preamble based on the preamble received target power ramping counter is not limited. For the specific calculation manner, reference may be made to the calculation manner agreed in a protocol, such as the calculation manner already defined in the protocol or a newly defined calculation manner in a subsequent protocol version.

In some embodiments, an actual transmit power of the preamble is calculated according to the following formula:

P_{PRACH,b,f,c}(i)=min{P_{CMAX,f,c}(i), P_{PRACH,target,f,c}+PL_{b,f,c}}; where
P_{CMAX,f,c}(i) represents a maximum transmit power configured for the terminal on carrier f of a serving cell at transmission occasion i (for example, the maximum transmit power of the terminal is 23 dBm); P_{PRACH,target,f,c} represents a physical random access channel (PRACH) target received power (PREAMBLE_RECEIVED_TARGET_POWER) on active uplink bandwidth part (UL BWP) b of carrier f of serving cell C; and PL_{b,f,c} represents a path loss of active UL BWP b of carrier f for a downlink reference signal associated with the PRACH transmission on the active downlink bandwidth part (DL BWP) of serving cell C, and PL_{b,f,c} may be equal to reference signal power minus higher layer filtered reference signal received power (higher layer filtered RSRP).

It should be noted that in the embodiments of this application, the calculation manner of the actual transmit power of the preamble is not limited. For the specific calculation manner, reference may be made to the calculation manner agreed in a protocol, such as the calculation manner already defined in the protocol or a newly defined calculation manner in a subsequent protocol version.

In some embodiments, a layer 1/layer 2 triggered mobility (L1/L2 triggered mobility, LTM) procedure is introduced. Specifically, the serving base station determines a target cell based on a layer 1 measurement result of the terminal, and uses a medium access control control element (MAC CE) to trigger the terminal to switch a primary cell or a primary secondary cell (or a primary cell group or a secondary cell group) to the target cell (or a target cell group). In the LTM procedure, the network side prepares a plurality of candidate cells in advance and sends configuration information of the candidate cells to the terminal through radio resource control (RRC) signaling. After the terminal performs cell change, the configuration information of the candidate cells stored by the terminal is not proactively released.

In order to reduce the delay of cell change, in the LTM procedure, the network side can trigger the terminal to perform early acquisition of a timing advance (TA) value of the candidate cell. Specifically, the network side sends a PDCCH order carrying an identifier of the candidate cell to the terminal. After receiving the PDCCH order, the terminal sends a preamble to the candidate cell indicated by the PDCCH order, and the network-side device of the candidate cell calculates a TA value of the terminal based on the preamble.

In some embodiments, the PDCCH order that triggers the early acquisition of the TA of the candidate cell carries indication information of the candidate cell and configuration information of a random access occasion of the candidate cell. In addition, the PDCCH order has 1 bit to explicitly indicate whether the PRACH transmission is an initial transmission or a retransmission.

In some embodiments, the TA value of the candidate cell is maintained by the serving base station. When the serving base station uses the MAC CE to trigger the terminal to execute LTM, if the serving base station maintains a valid TA value of the target cell, the TA value is carried in LTM cell switching signaling (MAC CE). After receiving the MAC CE, the terminal can acquire the TA value of the target cell, so there is no need to trigger a RACH procedure to the target cell, thereby enabling cell handover based on random access channel-less (RACH-less).

It should be noted that the above descriptions are only examples of the technology related to the embodiments of this application, and the embodiments of this application are not limited thereto.

The following describes in detail a power ramping counter processing method and apparatus, a command sending method and apparatus, and a device according to the embodiments of this application with reference to the accompanying drawings through some embodiments and application scenarios thereof.

Referring to FIG. 2, FIG. 2 is a flowchart of a power ramping counter processing method according to an embodiment of this application. As shown in FIG. 2, the method includes the following steps.

Step 201: A terminal receives a target PDCCH order, where the target PDCCH order is used to trigger the terminal to execute an early TA acquisition procedure of a target candidate cell.

The target PDCCH order is a target PDCCH order sent by a network-side device and received by the terminal.

The early TA acquisition procedure of the target candidate cell may be as follows:
sending, by the terminal, a preamble to a candidate cell indicated by the target PDCCH order, and calculating, by a network-side device of the candidate cell, a TA value of the terminal based on a preamble, and sending the acquired TA value to a serving network-side device of the terminal for maintenance.

Step 202: The terminal performs a first operation, where the first operation includes at least one of the following:
in a case that the terminal maintains a plurality of preamble received target power ramping counters, resetting or incrementing by 1, based on the target PDCCH order, a preamble received target power ramping counter associated with the target candidate cell; and
resetting or incrementing by 1, based on target information, a preamble received target power ramping counter, where the target information includes at least one of the following:
an association relationship between the target PDCCH order and another PDCCH order;
association information of the another PDCCH order;
detection information associated with the target PDCCH order; and
an association relationship between the early TA acquisition procedure of the target candidate cell triggered by the target PDCCH order and a last random access procedure; where
the another PDCCH order includes a PDCCH order received before the target PDCCH order is received; and the last random access procedure is a latest random access procedure executed before the early TA acquisition procedure of the target candidate cell, triggered by the target PDCCH order, is executed.

In the embodiments of this application, the preamble received target power ramping counter may also be referred to as a preamble power ramping counter (PREAMBLE_POWER_RAMPING_COUNTER), or a power ramping counter for short.

The plurality of preamble received target power ramping counters may be a plurality of preamble received target power ramping counters maintained for a plurality of cells or a plurality of cell groups.

The preamble received target power ramping counter associated with the target candidate cell may be a preamble received target power ramping counter of the target candidate cell, or a preamble received target power ramping counter of a cell group to which the target candidate cell belongs.

The resetting or incrementing by 1, based on target information, the preamble received target power ramping counter means resetting or incrementing by 1, based on the target information, the preamble received target power ramping counter maintained by the terminal, for example, resetting or incrementing by 1 based on the target information, one preamble received target power ramping counter maintained by the terminal. For example, in a case that the terminal maintains one preamble received target power ramping counter, the preamble received target power ramping counter is reset or incremented by 1 based on the target information. The maintaining one preamble received target power ramping counter may be maintaining one preamble received target power ramping counter in one medium access control (MAC) entity.

The another PDCCH order may be one or more PDCCH orders received before the terminal receives the target PDCCH order, for example, a PDCCH order with the smallest time interval from a reception time of the target PDCCH order, received by the terminal before the terminal receives the target PDCCH order.

In addition, the another PDCCH order may indicate a new transmission or indicate a retransmission, and is a PDCCH order used to trigger the terminal to execute the early TA acquisition procedure of the candidate cell. Indicating a new transmission means that the current early TA acquisition procedure of the candidate cell is the first transmission of the preamble, and indicating a retransmission means that the current early TA acquisition procedure of the candidate cell is not the first transmission of the preamble but a retransmission of the preamble.

The association relationship between the target PDCCH order and another PDCCH order may be a time association between the target PDCCH order and another PDCCH order, a relationship between indicated contents, or the like.

The association information of the another PDCCH order may be received signal quality information associated with the another PDCCH order, an order type, or the like.

The detection information associated with the target PDCCH order may be information detected by the terminal when or before the target PDCCH order is received.

The last random access procedure may be a latest random access procedure executed by the terminal before the terminal receives the target PDCCH order that triggers the terminal to execute the early TA acquisition procedure of the target candidate cell, that is, before the terminal triggers execution of a related random access procedure of the target candidate cell based on the target PDCCH order, for example, a random access procedure with the smallest time interval from and prior to the random access procedure triggered by the PDCCH order,

The association relationship between the early TA acquisition procedure of the target candidate cell and the last random access procedure may be an association relationship between a cell associated with the early TA acquisition procedure of the target candidate cell and a cell associated with the last random access procedure, or whether a last random access procedure exists, or the like.

In the embodiments of this application, the PDCCH order may also be referred to as PDCCH for short.

In the embodiments of this application, by maintaining a plurality of preamble received target power ramping counters, the terminal can separately reset or increment by 1 the counters for different candidate cells, allowing for more reasonable counting of the preamble received target power ramping counters maintained by the terminal, thereby improving the transmitting performance of the terminal in transmitting the preamble. In addition, since a plurality of preamble received target power ramping counters are maintained, the network-side device can promptly send a PDCCH order of another candidate cell after sending a PDCCH order of one candidate cell, thereby reducing the delay in acquiring TAs of a plurality of candidate cells of the terminal. For example, the terminal can promptly transmit the preamble to a plurality of candidate cells, thereby improving the transmitting performance of the terminal in transmitting the preamble, and improving the random access performance of the terminal.

Resetting or incrementing by 1, based on the target information, the counter can prevent unreasonable counting of the counter caused by the terminal missing a PDCCH order that indicates a new transmission, thereby improving the transmitting performance of the terminal in transmitting the preamble. For example, this can prevent the terminal from missing a PDCCH order indicating a new transmission. The terminal increments the counter by 1 based on a PDCCH order that indicates a retransmission, leading to an excessively high counter value. This in turns causes the terminal to transmit the preamble with an unnecessarily high power, resulting in high power consumption of the terminal random access. However, resetting or incrementing by 1 the counter based on the target information can avoid this situation. This ensures that the terminal uses appropriate power to transmit the preamble, thereby reducing the transmitting power of the terminal for transmitting the preamble, that is, improving the transmitting performance for transmitting the preamble, and reducing the power consumption of the terminal in the random access procedure.

In an optional manner, the association relationship between the target PDCCH order and another PDCCH order includes at least one of the following:
a relationship between candidate cell information indicated by the target PDCCH order and candidate cell information indicated by the another PDCCH order; and
a time relationship between the target PDCCH order and the another PDCCH order.

The candidate cell information may be a candidate configuration identifier (candidate configuration Id) indicated by the PDCCH order, or a cell identifier of a candidate cell indicated by the PDCCH order.

The relationship between the candidate cell information indicated by the target PDCCH order and the candidate cell information indicated by the another PDCCH order may be whether the candidate cell information indicated by the target PDCCH order is the same as the candidate cell information indicated by the another PDCCH order, or whether the candidate cell information indicated by the target PDCCH order and the candidate cell information indicated by the another PDCCH order are for a same candidate cell.

The time relationship between the target PDCCH order and the another PDCCH order may be a magnitude relationship of a reception time interval between the target PDCCH order and the another PDCCH order.

In this implementation, the preamble received target power ramping counter can be reset or increment by 1 based on the relationship between the candidate cell information indicated by the target PDCCH order and candidate cell information indicated by the another PDCCH order or the time relationship between the target PDCCH order and the another PDCCH order. This can prevent unreasonable counting of the preamble received target power ramping counter caused by the terminal missing a PDCCH that indicates a new transmission.

In an optional manner, in a case that the target information satisfies a first condition, the preamble received target power ramping counter is reset; or
in a case that the target information satisfies a second condition, the preamble received target power ramping counter is incremented by 1; where
the first condition and the second condition are different conditions.

The first condition and the second condition may be agreed in a protocol or configured by the network side.

In this implementation, the preamble received target power ramping counter can be reset or incremented by 1 based on different conditions satisfied by the target information, making the counting of the preamble received target power ramping counter more reasonable.

Optionally, the first condition includes at least one of the following:
the candidate cell information indicated by the target PDCCH order is different from the candidate cell information indicated by the another PDCCH order;
a reception time difference between the target PDCCH order and the another PDCCH order is greater than or equal to a first threshold; and
the target PDCCH order is received after a timer corresponding to the another PDCCH order expires.

In this implementation, when the candidate cell information indicated by the target PDCCH order is different from the candidate cell information indicated by the another PDCCH order, the preamble received target power ramping counter is reset, for example, the preamble received target power ramping counter is set to 1. If the target PDCCH order indicates a retransmission and the indicated candidate cell information is different from the candidate cell information indicated by the another PDCCH order, the preamble received target power ramping counter is reset. This can avoid that the terminal transmits the preamble with unnecessarily high power due to an excessively large value of the preamble received target power ramping counter, thereby reducing power consumption of the terminal in the random access procedure.

The first threshold is agreed in a protocol or configured by the network side.

In some implementations, the first threshold is a fixed value, or the first threshold is associated with at least one of the following:
a handover type, a candidate cell, a frequency, a frequency band, the terminal, and a type of the terminal; where
the handover type includes at least one of the following:
intra-distributed unit (DU) handover (Intra-DU), inter-DU handover (Inter-DU), intra-centralized unit (CU) handover (Intra-CU), and inter-CU handover (Inter-CU).

The first threshold being associated with at least one of the above items means that the first threshold is determined based on at least one of the above items. For example, Intra-DU and Inter-DU correspond to different first thresholds, Intra-CU and Inter-CU correspond to different first thresholds; different candidate cells correspond to different first thresholds; frequencies associated with different candidate cells correspond to different first thresholds; different frequency bands correspond to different first thresholds, where if a frequency band corresponding to the candidate cell is frequency range (FR) 1, it is one value, and if the frequency band corresponding to the candidate cell is FR2, it is another value; different terminals correspond to different first thresholds, and different terminal types correspond to different first thresholds.

Since the first threshold is associated with at least one of the handover type, the candidate cell, the frequency, the frequency band, the terminal, and the type of the terminal, a threshold that better matches the terminal can be flexibly configured, so that the value of the preamble received target power ramping counter better matches the terminal, achieving better random access performance for the terminal.

In the above implementation, in a case that the reception time difference between the target PDCCH order and the another PDCCH order is greater than or equal to the first threshold, the preamble received target power ramping counter can be reset, for example, the preamble received target power ramping counter is set to 1. If the target PDCCH order indicates a retransmission and the reception time difference from the another PDCCH order is greater than or equal to the first threshold, the preamble received target power ramping counter is reset. This can avoid that the terminal transmits the preamble with unnecessarily high power due to an excessively large value of the preamble received target power ramping counter, thereby reducing power consumption of the terminal in the random access procedure.

The timer corresponding to the another PDCCH order is a timer started or restarted for the another PDCCH order, and duration of the timer may be agreed in a protocol or configured by the network side. For example, a start or restart time of the timer corresponding to the another PDCCH order includes at least one of the following:
a time when the terminal receives the another PDCCH order; and
a delayed time after the time when the terminal receives the another PDCCH order.

The time unit of the above time may be slot, frame, subframe, second, millisecond, or microsecond. For example, the timer is started or restarted at the first slot, frame, subframe, second, millisecond, or microsecond after the terminal receives the another PDCCH order.

The delay may be a delay of N time units. For example, the timer is started or restarted after N slots, frames, subframes, seconds, milliseconds or microseconds following reception of the another PDCCH order.

In the embodiments of this application, the timer may also be referred to as a counter.

In some implementations, duration of the timer corresponding to the another PDCCH order is a fixed value, or duration of the timer corresponding to the another PDCCH order is associated with at least one of the following:
a handover type, a candidate cell, a frequency, a frequency band, the terminal, and a type of the terminal; where
the handover type includes at least one of the following:
intra-DU handover, inter-DU handover, intra-CU handover, and inter-CU handover.

The duration of the timer corresponding to the another PDCCH order being associated with at least one of the above items means that the duration of the timer is determined based on at least one of the above items. For example: Intra-DU and Inter-DU correspond to different durations, Intra-CU and Inter-CU correspond to different durations; different candidate cells correspond to different durations; frequencies associated with different candidate cells correspond to different durations; different frequency bands correspond to different durations, where if a frequency band corresponding to the candidate cell is FR1, it is one duration, and if the frequency band corresponding to the candidate cell is FR2, it is another duration; different terminals correspond to different durations, and different terminal types correspond to different durations.

Since the duration of the timer is associated with at least one of the handover type, the candidate cell, the frequency, the frequency band, the terminal, and the type of the terminal, a timer duration that better matches the terminal can be flexibly configured, so that the terminal can more accurately determine whether a PDCCH order indicating an initial transmission is missed, thereby setting an appropriate preamble received target power counter. This makes the counting of the preamble received target power ramping counter better match the terminal, and ensures that the terminal uses appropriate power to transmit the preamble.

In the above implementation, in a case that the target PDCCH order is received after the timer corresponding to the another PDCCH order expires, the preamble received target power ramping counter is reset, for example, the preamble received target power ramping counter is set to 1. If the target PDCCH order indicates a retransmission and is received after the timer corresponding to the another PDCCH order expires, the preamble received target power ramping counter is reset. This can avoid that the terminal transmits the preamble with unnecessarily high power due to an excessively large value of the preamble received target power ramping counter, thereby reducing power consumption of the terminal in the random access procedure.

Optionally, the second condition includes at least one of the following:
the candidate cell information indicated by the target PDCCH order is the same as the candidate cell information indicated by the another PDCCH order;
a reception time difference between the target PDCCH order and the another PDCCH order is less than or equal to a first threshold; and
the target PDCCH order is received before a timer corresponding to the another PDCCH order expires.

In this implementation, in a case that the candidate cell information indicated by the target PDCCH order is the same as the candidate cell information indicated by the another PDCCH order, or the reception time difference between the target PDCCH order and the another PDCCH order is less than or equal to the first threshold, or the target PDCCH order is received before the timer corresponding to the another PDCCH order expires, the preamble received target power ramping counter is incremented by 1. If the target PDCCH order indicates a retransmission and the indicated candidate cell information is the same as the candidate cell information indicated by the another PDCCH order, the preamble received target power ramping counter is incremented by 1. This can increase the transmitting power of the preamble for a same candidate cell, ensuring that the terminal uses appropriate power to transmit the preamble.

In an optional implementation, the association information of the another PDCCH order includes:
a signal quality of a serving cell associated with the another PDCCH order upon receiving of the another PDCCH order; and
a type of the another PDCCH order.

The serving cell associated with the another PDCCH order may refer to a cell in which the terminal receives the another PDCCH order, and the signal quality of the serving cell refers to a signal quality measured by the terminal upon receiving of the another PDCCH order.

The type of the another PDCCH order may be a function type of the another PDCCH order, for example, a PDCCH order used to trigger the UE to execute a normal random access procedure, where the normal random access procedure is a random access procedure other than an early acquisition procedure of a candidate cell by the terminal.

In this implementation, the preamble received target power ramping counter can be reset or incremented by 1 based on the signal quality of the serving cell associated with the another PDCCH order upon receiving of the another PDCCH order or the type of the another PDCCH order. This can prevent unreasonable counting of the preamble received target power ramping counter caused by the terminal missing a PDCCH that indicates a new transmission.

In some implementations, the association information of the another PDCCH order may alternatively be a signal quality of a serving cell associated with the another PDCCH order before the another PDCCH order is received.

In an optional implementation, the detection information associated with the target PDCCH order includes:
whether a beam failure occurs before the target PDCCH order is received;
a signal quality of a serving cell associated with the target PDCCH order; and
whether a PDCCH order used to trigger the early acquisition of a TA of a candidate cell is received before the target PDCCH order is received.

That whether a beam failure occurs before the target PDCCH order is received may refer to whether the terminal detects a beam failure before the target PDCCH is received, for example, whether a beam failure is detected within a preset time before the target PDCCH order is received, where the preset time may be agreed in a protocol or configured by the network side.

In some implementations, the signal quality of the serving cell associated with the target PDCCH order includes at least one of the following:
a signal quality of the serving cell associated with the target PDCCH order when the target PDCCH order is received; and
a signal quality of the serving cell associated with the target PDCCH order before the target PDCCH order is received.

The signal quality of the serving cell associated with the target PDCCH order before the target PDCCH order is received may be a signal quality of the serving cell associated with the target PDCCH order within a preset time before the target PDCCH order is received, where the preset time may be agreed in a protocol or configured by the network side.

That whether a PDCCH order used to trigger the early acquisition of a TA of a candidate cell is received before the target PDCCH order is received may be: whether a PDCCH order used to trigger the early acquisition of a TA of a candidate cell is received within a preset time before the target PDCCH order is received, where the preset time may be agreed in a protocol or configured by the network side.

In this implementation, the preamble received target power ramping counter can be reset or incremented by 1 based on the detection information associated with the target PDCCH order. This can prevent unreasonable counting of the preamble received target power ramping counter caused by the terminal missing a PDCCH that indicates a new transmission.

Optionally, the first condition includes at least one of the following:
the signal quality of the serving cell associated with the another PDCCH order is lower than or equal to a second threshold;
the another PDCCH order is the latest PDCCH order received by the terminal before the target PDCCH order is received, and the type of the another PDCCH order is a PDCCH order used to trigger the terminal to execute a normal random access procedure;
a beam failure occurs before the target PDCCH order is received;
the signal quality of the serving cell associated with the target PDCCH order is lower than or equal to a third threshold; and
no PDCCH order used to trigger the early acquisition of a TA of a candidate cell is received before the target PDCCH order is received.

The second threshold and the third threshold are agreed in a protocol or configured by the network side.

The normal random access procedure refers to a random access procedure in which the early TA acquisition procedure of the candidate cell is not executed.

In the above implementation, the preamble received target power ramping counter can be reset under at least one of the above conditions. For example, if the target PDCCH order indicates a retransmission but at least one of the above conditions is satisfied, the preamble received target power ramping counter is reset. This can avoid that the terminal transmits the preamble with unnecessarily high power due to an excessively large value of the preamble received target power ramping counter, thereby reducing power consumption of the terminal in the random access procedure.

It should be noted that the first condition may also be combined with the first condition in the above implementation. For example, in some implementations, the first condition includes at least one of the following:
the candidate cell information indicated by the target PDCCH order is different from the candidate cell information indicated by the another PDCCH order;
a reception time difference between the target PDCCH order and the another PDCCH order is greater than or equal to a first threshold;
the target PDCCH order is received after a timer corresponding to the another PDCCH order expires;
the signal quality of the serving cell associated with the another PDCCH order is lower than or equal to a second threshold;
the another PDCCH order is the latest PDCCH order received by the terminal before the target PDCCH order is received, and the type of the another PDCCH order is a PDCCH order used to trigger the terminal to execute a normal random access procedure;
a beam failure occurs before the target PDCCH order is received;
the signal quality of the serving cell associated with the target PDCCH order is lower than or equal to a third threshold; and
no PDCCH order used to trigger the early acquisition of a TA of a candidate cell is received before the target PDCCH order is received.

In this way, the preamble received target power ramping counter can be more flexibly reset.

In an optional implementation, the another PDCCH order in the embodiments of this application includes:
a PDCCH order that is most recently received before the target PDCCH order is received, is used to trigger the terminal to execute the early TA acquisition procedure of the candidate cell, and indicates a new transmission; or
a PDCCH order that is most recently received before the target PDCCH order is received and is used to trigger the terminal to execute the early TA acquisition procedure of the candidate cell.

The PDCCH order used to trigger the terminal to execute the early TA acquisition procedure of the candidate cell may mean that whether the PDCCH order indicates a new transmission or a retransmission is not limited.

In this implementation, the preamble received target power ramping counter can be reset or incremented by 1 based on the PDCCH order most recently received before the target PDCCH order is received, making the counting of the preamble received target power ramping counter more reliable. For example, the preamble received target power ramping counter is reset under at least one of the following conditions:
the signal quality of the serving cell associated with the another PDCCH order is lower than or equal to a second threshold;
the candidate cell information indicated by the target PDCCH order is different from the candidate cell information indicated by the another PDCCH order;
a reception time difference between the target PDCCH order and the another PDCCH order is greater than or equal to a first threshold; and
the target PDCCH order is received after a timer corresponding to the another PDCCH order expires.

In an optional implementation, the association relationship between the early TA acquisition procedure of the target candidate cell triggered by the target PDCCH order and the last random access procedure includes:
an association relationship between a cell associated with the early TA acquisition procedure of the target candidate cell triggered by the target PDCCH order and a cell associated with the last random access procedure; or
whether the last random access procedure exists before the early TA acquisition procedure of the target candidate cell triggered by the target PDCCH order is performed.

The early TA acquisition procedure of the target candidate cell triggered by the target PDCCH order may be that the UE executes a random access procedure to the target candidate cell indicated in the target PDCCH order to acquire the TA of the target candidate cell.

The cell associated with the early TA acquisition procedure of the target candidate cell triggered by the target PDCCH order may be a candidate cell corresponding to a random access procedure in which the terminal executes the early TA acquisition procedure of the target candidate cell. The terminal sends the preamble to this candidate cell.

The cell associated with the last random access procedure may be a cell for which the terminal executes the last random access procedure. The terminal sends the preamble to this cell.

The relationship between the cell associated with the early TA acquisition procedure of the target candidate cell and the cell associated with the last random access procedure may be expressed as: whether the cell associated with the early TA acquisition procedure of the target candidate cell is the same as the cell associated with the last random access procedure; or whether the last random access procedure has been executed before the terminal executes the early TA acquisition procedure of the target candidate cell.

In this implementation, the preamble received target power ramping counter can be reset or incremented by 1 based on the association relationship between the early TA acquisition procedure of the target candidate cell and the last random access procedure. This can prevent unreasonable counting of the preamble received target power ramping counter caused by the terminal executing the random access procedure of the serving cell when the early TA acquisition procedure of the target candidate cell executed by the terminal conflicts with the last random access procedure of the corresponding serving cell (that is, a first time domain resource corresponding to the last random access procedure overlaps with or is too close to a second time-frequency resource corresponding to the random access procedure associated with the early TA acquisition procedure of the target candidate cell or the interval is too small), thereby preventing the problem of inappropriate power for transmitting the preamble.

In this implementation, the first condition includes at least one of the following:
the early TA acquisition procedure of the target candidate cell and the last random access procedure are associated with different cells; and
the last random access procedure does not exist.

In this implementation, when the early TA acquisition procedure of the target candidate cell and the last executed random access procedure are for different cells, even if the target PDCCH order indicates a retransmission, the preamble received target power ramping counter can also be reset, for example, the preamble received target power ramping counter is set to 1. Alternatively, even if the target PDCCH order indicates a retransmission, if the terminal has not executed any random access procedure before executing the random access procedure triggered by the target PDCCH order, the preamble received target power ramping counter is reset. This can avoid that the terminal transmits the preamble with unnecessarily high power due to an excessively large value of the preamble received target power ramping counter, thereby reducing power consumption of the terminal in the random access procedure.

In this implementation, the second condition includes:
the early TA acquisition procedure of the target candidate cell and the last random access procedure are associated with a same cell; and
the target PDCCH order indicates a retransmission.

In this implementation, the preamble received target power ramping counter can be incremented by 1 when the early TA acquisition procedure of the target candidate cell triggered by the target PDCCH order and the last random access procedure are associated with a same cell, that is, the preamble is sent to a same cell, and the target PDCCH indicates a retransmission. This can increase the transmitting power of the preamble for a same candidate cell, ensuring that the terminal uses appropriate power to transmit the preamble.

In an optional implementation, the plurality of preamble received target power ramping counters include at least one of the following:
a preamble received target power ramping counter associated with the serving cell;
a preamble received target power ramping counter associated with a plurality of candidate cells; and
a preamble received target power ramping counter associated with a plurality of candidate cell groups.

The plurality of candidate cells may be cells associated with a plurality of candidate configuration identifiers (configuration ID), or cells associated with a plurality of candidate configurations, meaning that one candidate cell is a cell associated with one configuration identifier or a cell associated with one candidate configuration.

One candidate cell group may be a candidate cell group composed of cells associated with one or more configuration identifiers. Alternatively, one candidate cell group is any several candidate cells allocated by the network side, or candidate cells belonging to a same DU or CU, or candidate cells belonging to a same frequency, or candidate cells belonging to a same frequency band.

In this implementation, the preamble received target power ramping counter can be associated with the serving cell, and corresponding preamble received target power ramping counters can be maintained for a plurality of candidate cells or a plurality of candidate cell groups. This makes the counting of these preamble received target power ramping counters more reliable, and allows the network-side device to promptly send a PDCCH order of another candidate cell after sending a PDCCH order of one candidate cell, thereby reducing the delay in acquiring TAs of a plurality of candidate cells of the terminal.

In some implementations, when the target PDCCH order indicates an initial transmission, the terminal resets the preamble received target power ramping counter associated with the target candidate cell; and when the target PDCCH order indicates a retransmission, the terminal increments by 1 the preamble received target power ramping counter associated with the target candidate cell.

Optionally, under a third condition, the preamble received target power ramping counter associated with the target candidate cell is reset, or a preamble received target power ramping counter associated with a candidate cell group to which the target candidate cell belongs is reset; where
the third condition includes at least one of the following:
a target timer expires, where the target timer includes a timer associated with the target candidate cell, or a timer associated with the candidate cell group to which the target candidate cell belongs;
a reception time difference between the target PDCCH order and a PDCCH order associated with the target PDCCH order that indicates a new transmission is greater than or equal to a fourth threshold;
the terminal performs cell handover;
a counter is greater than a fifth threshold, where the counter includes a counter associated with the target candidate cell, or a counter associated with the candidate cell group to which the target candidate cell belongs; and
the target PDCCH order indicates a new transmission; or the target PDCCH order indicates a retransmission, where the terminal has not received a PDCCH order associated with the target PDCCH order that indicates a new transmission before the target PDCCH order that indicates a retransmission is received.

The PDCCH order associated with the target PDCCH order that indicates a new transmission may be a PDCCH order used to trigger the terminal to execute the early TA acquisition procedure of the target candidate cell and indicate a new transmission.

In some implementations, a start or restart time of the target timer includes:
a reception time of the PDCCH order associated with the target PDCCH order that indicates a new transmission; or
a reception time of the PDCCH order associated with the target PDCCH order that indicates a retransmission, where the terminal has not received the PDCCH order associated with the target PDCCH order that indicates a new transmission before the target PDCCH order that indicates a retransmission is received.

That the terminal has not received the PDCCH order associated with the target PDCCH order that indicates a new transmission before the target PDCCH order that indicates a retransmission is received may be understood as that the terminal has missed the PDCCH order associated with the target PDCCH order that indicates a new transmission before the target PDCCH order that indicates a retransmission is received. For example, the terminal has not received any PDCCH order used to trigger the early acquisition of the TA of the candidate cell before the target PDCCH order that indicates a retransmission is received, or the latest PDCCH order received by the terminal before the target PDCCH order that indicates a retransmission is received is a PDCCH order for normal random access, that is, a legacy PDCCH order used to trigger random access (legacy PDCCH order for Random access).

The counter and the timer may be configured separately for different candidate cells, or configured separately for each candidate cell group.

The fourth threshold and the fifth threshold may be agreed in a protocol or configured by the network side. In addition, values of the fourth threshold and the fifth threshold may be the same or different for different candidate cells, or values of the fourth threshold and the fifth threshold may be the same or different for different candidate cell groups.

In some implementations, the counter is incremented by 1 in the following case:
the target PDCCH order indicating a retransmission is received, but it cannot be determined through the target PDCCH order whether the PDCCH order associated with the target PDCCH order that indicates a new transmission is missed.

For example, if the terminal receives a PDCCH order that carries an identifier of a candidate cell or candidate cell group associated with the counter and indicates a retransmission, but the terminal cannot determine through the PDCCH order whether the associated PDCCH order indicating a new transmission is missed, or the terminal considers that it does not miss the associated PDCCH order indicating a new transmission) the counter is incremented by 1.

In some implementations, the counter is reset in the following case:
at a reception time of the target PDCCH order that indicates a new transmission; or
at a reception time of the target PDCCH order that indicates a retransmission, where the terminal has not received the PDCCH order associated with the target PDCCH order that indicates a new transmission before the target PDCCH order that indicates a retransmission is received.

In the above implementation, the preamble received target power ramping counter associated with the target candidate cell or the candidate cell group to which the target candidate cell belongs can be reset in a case that the target timer expires, or in a case that the reception time difference between the target PDCCH order and the PDCCH order associated with the target PDCCH order that indicates a new transmission is greater than or equal to the fourth threshold, or in a case that the terminal performs cell handover, or in a case that the counter is greater than the fifth threshold, or in a case that the target PDCCH order indicates a new transmission, or in a case that the target PDCCH order indicates a retransmission but the terminal has not received the PDCCH order associated with the target PDCCH order that indicates a new transmission before the target PDCCH order that indicates a retransmission is received. This can prevent the terminal from transmitting the preamble with excessively high power, thereby reducing power consumption of the terminal in the random access procedure.

In the embodiments of this application, a terminal receives a target PDCCH order, where the target PDCCH order is used to trigger the terminal to execute an early TA acquisition procedure of a target candidate cell; and the terminal performs a first operation, where the first operation includes at least one of the following: in a case that the terminal maintains a plurality of preamble received target power ramping counters, resetting or incrementing by 1, based on the target PDCCH order, a preamble received target power ramping counter associated with the target candidate cell; and resetting or incrementing by 1, based on target information, a preamble received target power ramping counter, where the target information includes at least one of the following: an association relationship between the target PDCCH order and another PDCCH order; association information of the another PDCCH order; detection information associated with the target PDCCH order; and an association relationship between the early TA acquisition procedure of the target candidate cell and a last random access procedure; where the another PDCCH order includes a PDCCH order received before the target PDCCH order is received; and the last random access procedure is a latest random access procedure executed before the early timing advance acquisition procedure of the target candidate cell is executed. In this way, by maintaining a plurality of preamble received target power ramping counters, the terminal can separately reset or increment the counters for different candidate cells, allowing for more reasonable counting of the preamble received target power ramping counters maintained by the terminal, thereby improving the transmitting performance of the terminal in transmitting the preamble. Furthermore, resetting or incrementing by 1, based on the target information, the counter can prevent unreasonable counting of the counter caused by the terminal missing a PDCCH order that indicates a new transmission, thereby improving the transmitting performance of the terminal in transmitting the preamble.

Referring to FIG. 3, FIG. 3 is a flowchart of a command sending method according to an embodiment of this application. As shown in FIG. 3, the method includes the following steps.

Step 301: A network-side device sends a first PDCCH order to a terminal, where the first PDCCH order is used to trigger execution of an early TA acquisition procedure of a first candidate cell and indicate a new transmission.

The first PDCCH order may be the target PDCCH order or another PDCCH order in the embodiment shown in FIG. 2. Reference may be made to the corresponding description in the embodiment shown in FIG. 2, and details are not repeated herein.

Step 302: The network-side device sends a second PDCCH order to the terminal under a target condition, where the second PDCCH order is used to trigger execution of an early TA acquisition procedure of a second candidate cell; and
the target condition includes any one of the following:
the network-side device confirms that the early TA acquisition procedure of the first candidate cell is completed successfully, or the network-side device confirms that the early TA acquisition procedure of the first candidate cell is not completed successfully;
the network-side device successfully sends the first PDCCH order; and
the network-side device successfully triggers the terminal to execute the early TA acquisition procedure of the first candidate cell.

That the network-side device confirms that the early TA acquisition procedure of the first candidate cell is not completed successfully may mean that the network-side device has executed the early TA acquisition procedure of the first candidate cell but has not successfully acquired the TA of the first candidate cell, or that the network-side device determines that early acquisition of the TA of the first candidate cell fails.

In this embodiment, the second PDCCH order is sent to the terminal under the condition that the network-side device confirms that the early TA acquisition procedure of the first candidate cell is completed successfully or confirms that the early TA acquisition procedure of the first candidate cell is not completed successfully. This, in a case that the terminal maintains one preamble received target power ramping counter, prevents the terminal from resetting the preamble received target power ramping counter based on the second PDCCH order. As a result, the terminal can select a higher transmission power to transmit the preamble for the first candidate cell, thereby improving the transmitting performance of the terminal for transmitting the preamble.

In this embodiment, since the second PDCCH order is sent to the terminal when the network-side device successfully triggers the terminal to execute the early TA acquisition procedure of the first candidate cell, the delay in acquiring the TA of the first candidate cell and the TA of the second candidate cell of the terminal can be reduced. As a result, the terminal can more quickly send the preamble to the second candidate cell, thereby improving the transmitting performance of the terminal for transmitting the preamble.

In some implementations, in a case that the terminal maintains one preamble received target power ramping counter, the target condition includes: the network-side device confirms that the early TA acquisition procedure of the first candidate cell is completed successfully, or the network-side device confirms that the early TA acquisition procedure of the first candidate cell is not completed successfully.

In some implementations, in a case that the terminal maintains a plurality of preamble received target power ramping counters, the target condition includes: the network-side device successfully sends the first PDCCH order, or the network-side device successfully triggers the terminal to execute the early TA acquisition procedure of the first candidate cell.

Optionally, before a first timer expires, the network-side device acquires the TA of the first candidate cell and determines that the early TA acquisition procedure of the first candidate cell is completed successfully; and
the method further includes:
after the first timer expires, if the network-side device has not acquired the TA of the first candidate cell, sending, by the network-side device, a third PDCCH order to the terminal, where the third PDCCH order is used to trigger execution of the early TA acquisition procedure of the first candidate cell and indicate a retransmission; where
a start or restart time of the first timer includes:
a time when the network-side device sends the first PDCCH order; and
a delayed time after the time when the network-side device sends the first PDCCH order.

The delay may be a delay of one or more time units, such as one or more seconds, milliseconds, microseconds, frames, subframes, slots, or symbols.

The delayed duration may be a fixed duration, or a variable duration associated with at least one of the following:
a candidate cell, measurement report of the terminal, a capability of the terminal, and a location of the terminal.

Being associated with a candidate cell may be being associated with an identifier of the candidate cell, a DU corresponding to the candidate cell, or frequency or frequency band information corresponding to the candidate cell.

A duration of the first timer is associated with at least one of the following:
a handover type, a candidate cell, a frequency, a frequency band, the terminal, and a type of the terminal; where
the handover type includes at least one of the following:
intra-DU handover, inter-DU handover, intra-CU handover, and inter-CU handover.

In the embodiment, successful completion of the early TA acquisition procedure of the first candidate cell can be determined based on the first timer, allowing timely sending of the second PDCCH order to the terminal, thereby reducing the delay in acquiring the TA of the second candidate cell of the terminal.

Moreover, the third PDCCH order can be sent to the terminal based on the first timer, indicating the terminal to retransmit the preamble in time, thereby improve the transmitting performance of the terminal for transmitting the preamble.

Optionally, in a first case, the network-side device acquires the TA of the first candidate cell and determines that the early TA acquisition procedure of the first candidate cell is completed successfully; or
in a second case, the network-side device has not acquired the TA of the first candidate cell and confirms that the early TA acquisition procedure of the first candidate cell is not completed successfully; where
the first case includes that the first timer has not expired, and further includes at least one of the following:
a counter is less than or equal to a threshold, and a second timer has not expired;
the second case includes at least one of the following:
a counter is greater than a threshold, and a second timer expires.

The counter is incremented by 1 when the network-side device sends the third PDCCH order; and
a start or restart time of the second timer includes:
a time when the network-side device triggers for the first time the terminal to execute the early TA acquisition procedure of the first candidate cell; or
a time when the successful completion of the early TA acquisition procedure of the first candidate cell is determined.

A duration of the second timer is fixed, or the duration of the second timer is associated with at least one of the following:
a handover type, a candidate cell, a frequency, a frequency band, the terminal, and a type of the terminal; where
the handover type includes at least one of the following:
intra-DU handover, inter-DU handover, intra-CU handover, and inter-CU handover.

In some implementations, the length of the second timer is longer than that of the first timer, for example, is an integer multiple of the first timer.

The threshold corresponding to the counter may be agreed in a protocol or configured by the network side. For example, the threshold is a fixed threshold, or the threshold is associated with at least one of the following:
a handover type, a candidate cell, a frequency, a frequency band, the terminal, and a type of the terminal; where
the handover type includes at least one of the following:
intra-DU handover, inter-DU handover, intra-CU handover, and inter-CU handover.

In this implementation, based on the counter or the second timer, it can be accurately determined that the early TA acquisition procedure of the first candidate cell is successfully completed, or it can be accurately confirmed that the early TA acquisition procedure of the first candidate cell is not successfully completed, allowing timely sending of the above second PDCCH order to the terminal, thereby reducing the delay in acquiring the TA of the second candidate cell of the terminal.

Optionally, the sending, by the network-side device, a second PDCCH order to the terminal under a target condition includes:
sending, by the network-side device, the second PDCCH order to the terminal at a time when the terminal is successfully triggered to execute the early TA acquisition procedure of the first candidate cell; or
sending, by the network-side device, the second PDCCH order to the terminal at a delayed time after the time when the first PDCCH order is successfully sent.

The delayed duration may be agreed in a protocol or configured by the network side.

In this implementation, the second PDCCH order can be flexibly sent to the terminal, meeting the requirements of different scenarios or services.

Optionally, the first candidate cell and the second candidate cell belong to different candidate cell groups.

In this implementation, in a case that the terminal maintains preamble received target power ramping counters of a plurality of candidate cell groups, the counting of the preamble received target power ramping counters maintained by the terminal is more reasonable.

It should be noted that this embodiment serves as an implementation of the network-side device corresponding to the embodiment shown in FIG. 2, and for its specific implementation, reference may be made to the relevant description of the embodiment shown in FIG. 2. To avoid repeated description, details are not repeated in this embodiment.

The method provided in the embodiments of this application is illustrated below through a plurality of embodiments:

### Embodiment 1

This embodiment mainly describes that a source gNB does not trigger a terminal to execute an early TA acquisition procedure of another candidate cell or trigger the terminal to execute other random access procedures, before triggering the terminal to complete an early TA acquisition procedure of a first candidate cell, so as to avoid unreasonable counting of a preamble received target power ramping counter of the terminal. Specifically, the following steps are included.

Step 1: The source gNB sends an RRC reconfiguration message carrying configuration information of one or more candidate cells to the terminal.

Step 2: The source gNB sends a PDCCH order to the terminal to trigger the terminal to execute an early TA acquisition procedure of candidate cell #1 (C-cell#1), where the PDCCH order indicates an initial scheduling for the terminal, and carries at least one of the following information:
a candidate cell identifier, such as a configuration identifier (configuration ID) or a cell identifier;
indication information of preamble retransmission or initial transmission;
a random access preamble index;
an uplink/supplementary uplink indicator (UL/SUL indicator);
synchronization signal/physical broadcast channel index (SS/PBCH index); and
PRACH mask index (PRACH Mask index).

Step 3: The Source gNB starts a first timer at a first time, where
the first time is any one of the following times:
a time when the source gNB successfully sends the PDCCH order that triggers the terminal to execute the early TA acquisition procedure of the candidate cell; and
a time after a first duration has elapsed since the successful sending of the PDCCH order by the source gNB; where
the first duration may be any one of the following:
a fixed duration; and
a variable duration determined based on different candidate cells (including identifiers of the candidate cells, DUs corresponding to the candidate cells, and frequency or frequency band information corresponding to the candidate cells), and/or measurement report of the terminal, and/or a capability of the terminal, and/or a location of the terminal.

The unit of the first duration may be second, millisecond, microsecond, frame, subframe, slot, or symbol.

The unit of the first time may be frame, subframe, slot, symbol, second, millisecond, or microsecond.

The duration of the first timer may be any one of the following:
a fixed length;
different durations of the first timer corresponding to Intra-DU and Inter-DU;
different durations of the first timer corresponding to different candidate cells;
different durations of the first timer corresponding to different frequencies;
different durations of the first timer corresponding to different frequency bands;
different durations of the first timer corresponding to different terminals; and
different durations of the first timer corresponding to different terminal types.

Optionally, the source gNB maintains a first counter and resets it in a case that the source gNB triggers for the first time the terminal to execute the early TA acquisition procedure of the first candidate cell (that is, the PDCCH order indicates a new transmission), including setting the first counter to 1 or 0; or the source gNB maintains a second timer and resets it in a case that the source gNB triggers for the first time the terminal to execute the early TA acquisition procedure of the first candidate cell (that is, the PDCCH order indicates a new transmission); where
a length of the second timer is fixed, or Intra-DU and Inter-DU correspond to different durations of the second timer, or a duration of the second timer is determined in a same manner for determining the duration of the first timer.

A value of the first threshold corresponding to the first counter may be fixed, or Intra-DU and Inter-DU correspond to different first thresholds, where the value of the first threshold is determined in same manner for determining the duration of the first timer.

In some implementations, the length of the second timer is longer than that of the first timer, and optionally, is an integer multiple of the first timer.

Step 4: If the source gNB receives the TA value of the candidate cell (C-cell) #1 before the first counter is less than or equal to the first threshold or before the second timer expires, and before the first timer expires, the source gNB considers that the early TA acquisition procedure of C-cell#1 is successfully completed, and the source gNB stops the first timer and the second timer (if configured); if the source gNB has not received the TA value of C-cell#1 after the first timer expires, the source gNB re-triggers the terminal to execute the early TA acquisition procedure of C-cell#1; and the first counter is incremented by 1 (if the first counter has been configured); and
if the source gNB successfully completes the early TA acquisition procedure of C-cell#1, the source gNB resets the second timer or resets the first counter.

If the early TA acquisition procedure of C-cell#1 is not successfully completed after the first counter is greater than or equal to the first threshold or the second timer expires, the source gNB considers that the early TA acquisition procedure of C-cell#1 is not successfully completed.

Step 5: After completing (including successfully completing or unsuccessfully completing) the early TA acquisition procedure of C-cell#1, the source gNB may trigger the terminal to execute the early TA acquisition procedures of other candidate cells excluding C-cell#1; otherwise, it is not allowed to trigger the terminal to execute the early TA acquisition procedures of other candidate cells excluding C-cell#1.

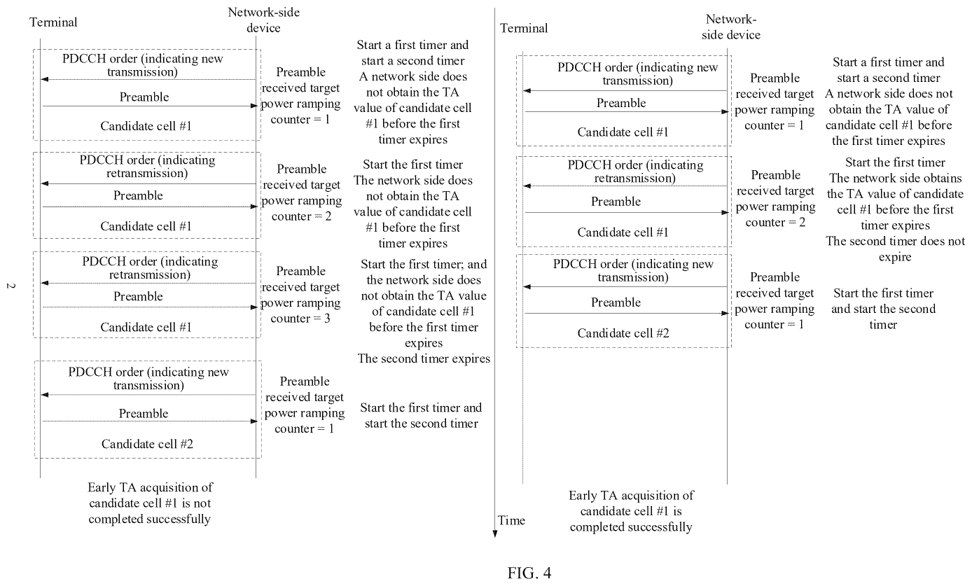

In this embodiment, the preamble received target power ramping counter of the terminal is specifically shown in FIG. 4.

In this embodiment, the source gNB can trigger the terminal to obtain the TA values of other candidate cells after obtaining the TA value of one candidate cell. This can avoid the terminal being unable to use higher transmitting power to transmit the preamble, thereby improving the probability of successfully acquiring the TA value of the candidate cell. For example: a MAC entity of the terminal has only one preamble received target power ramping counter (PREAMBLE_POWER_RAMPING_COUNTER), so only one preamble received target power (PREAMBLE_RECEIVED_TARGET_POWER) can be acquired. If the source gNB does not execute the method provided in this embodiment, the PREAMBLE_POWER_RAMPING_COUNTER is always reset to 1 such that in a case of failure to obtain the TA value of one candidate cell, the terminal cannot use higher preamble transmission power to transmit the preamble, reducing the probability of successfully acquiring the TA value of the candidate cell.

### Embodiment 2

Generally, the terminal maintains one preamble received target power ramping counter (PREAMBLE_POWER_RAMPING_COUNTER) in one MAC entity. When the terminal receives a PDCCH order that triggers the terminal to execute the early TA acquisition procedure of the candidate cell and indicates a new transmission, the terminal sets the PREAMBLE_POWER_RAMPING_COUNTER to 1; when the terminal receives a PDCCH order that triggers the terminal to execute the early TA acquisition procedure of the candidate cell and indicates a retransmission, the terminal increments the PREAMBLE_POWER_RAMPING_COUNTER by 1.

In this embodiment, the terminal receives a first PDCCH order, where the first PDCCH order is used to trigger the terminal to execute the early TA acquisition procedure of the candidate cell, and the first PDCCH order indicates a retransmission, the terminal sets the current PREAMBLE_POWER_RAMPING_COUNTER to 1 when one of the following is satisfied.

Solution 1-1: If the candidate configuration Id indicated in the first PDCCH order is different from that indicated in a second PDCCH order, the second PDCCH order is used to trigger the terminal to execute the early TA acquisition procedure of the candidate cell, and the second PDCCH order indicates a new transmission, and the second PDCCH order is the latest PDCCH order indicating a new transmission and received before the first PDCCH order.

Solution 1-2: If the candidate configuration Id indicated in the first PDCCH order is different from that indicated in a third PDCCH order, the third PDCCH order is used to trigger the terminal to execute the early TA acquisition procedure of the candidate cell, and the third PDCCH order is the latest PDCCH order used to trigger the terminal to execute the early TA acquisition procedure of the candidate cell and received before the first PDCCH order.

Solution 2: If the terminal detects a beam failure before the first PDCCH order is received or an RSRP of the cell receiving the PDCCH order, measured by the terminal, is lower than a second threshold, the terminal sets the current PREAMBLE_POWER_RAMPING_COUNTER to 1.

The second threshold is agreed in a protocol or configured by the network.

Solution 3-1: the time difference between the first PDCCH order received by the terminal and the second PDCCH order is greater than a third threshold.

For the first PDCCH order and the second PDCCH order, reference may be made to the corresponding description in solution 1, and details are not repeated herein.

The third threshold is agreed in a protocol or configured by the network, and the third threshold may be any one of the following:
a fixed length;
different third thresholds corresponding to Intra-DU and Inter-DU;
different third thresholds corresponding to different candidate cells;
different third thresholds corresponding to frequencies associated with different candidate cells;
different third thresholds corresponding to different frequency bands, meaning that the third threshold is one value if the frequency band corresponding to the candidate cell is FR1, or another value if the frequency band corresponding to the candidate cell is FR2;
different third thresholds corresponding to different terminals; and
different third thresholds corresponding to different terminal types.

Solution 3-2: The terminal receives the first PDCCH order after a third timer expires, where a length of the third timer is agreed in a protocol or configured by the network, and a start or restart time of the third timer is any one of the following times:
a time when the terminal receives the second PDCCH order; and
a time after a second duration has elapsed since reception of the second PDCCH order by the terminal, for example, N slots, frames, subframes, seconds, milliseconds, or microseconds after the second PDCCH order is received; where the second duration may be a fixed length, or different terminals or terminal types correspond to different second durations.

Solution 4-1: If a time difference between the first PDCCH order and the second PDCCH order that are received by the terminal is less than the third threshold, even if the solution 1-1 is satisfied, the value of PREAMBLE_POWER_RAMPING_COUNTER is still incremented by 1; if the time difference between the first PDCCH order and the second PDCCH order that are received by the terminal is not less than the third threshold and the solution 1-1 is satisfied, the value of PREAMBLE_POWER_RAMPING_COUNTER is set to 1.

Solution 4-2: If the terminal has received the first PDCCH order before the third timer expires, even if the solution 1-1 is satisfied, the value of PREAMBLE_POWER_RAMPING_COUNTER is still incremented by 1; if the terminal receives the first PDCCH order after the third timer expires and the solution 1-1 is satisfied, the value of PREAMBLE_POWER_RAMPING_COUNTER is set to 1.

In this way, when a PDCCH order is received, if the third timer is running and the solution 1 is satisfied, PREAMBLE_POWER_RAMPING_COUNTER is incremented by 1; otherwise, PREAMBLE_POWER_RAMPING_COUNTER is reset.

Solution 5-1: A time difference between the first PDCCH order and the third PDCCH order that are received by the terminal is greater than a fourth threshold.

For the first PDCCH order and the third PDCCH order, reference may be made to the corresponding description in solution 1, and details are not repeated herein.

The fourth threshold is agreed in a protocol or configured by the network, and the fourth threshold may be any one of the following:
a fixed length;
different fourth thresholds corresponding to Intra-DU and Inter-DU;
different fourth thresholds corresponding to different candidate cells;
different fourth thresholds corresponding to different frequencies;
different fourth thresholds corresponding to different frequency bands;
different fourth thresholds corresponding to different terminals; and
different fourth thresholds corresponding to different terminal types.

Solution 5-2: The terminal receives the first PDCCH order after a fourth timer expires, where a length of the fourth timer is agreed in a protocol or configured by the network, and a start or restart time of the fourth timer is any one of the following times:
a time when the terminal receives the third PDCCH order; and
a time after a third duration has elapsed since reception of the third PDCCH order by the terminal, for example, N slots, frames, subframes, seconds, milliseconds, or microseconds after the third PDCCH order is received, where the third duration may be a fixed length, or different terminals or terminal types correspond to different third durations.

Solution 6-1: If a time difference between the first PDCCH order and the third PDCCH order that are received by the terminal is less than the fourth threshold, even if the solution 1-2 is satisfied, the value of PREAMBLE_POWER_RAMPING_COUNTER is still incremented by 1; if the time difference between the first PDCCH order and the third PDCCH order that are received by the terminal is not less than the fourth threshold and the solution 1-2 is satisfied, the value of PREAMBLE_POWER_RAMPING_COUNTER is set to 1.

Solution 6-2: If the terminal receives the first PDCCH order before the fourth timer expires, even if the solution 1-2 is satisfied, the value of PREAMBLE_POWER_RAMPING_COUNTER is still incremented by 1; if the terminal receives the first PDCCH order after the fourth timer expires and the solution 1-2 is satisfied, the value of PREAMBLE_POWER_RAMPING_COUNTER is set to 1.

Solution 7: Before the first PDCCH order is received, the terminal has not received any PDCCH order used to trigger the early acquisition of the TA value of the candidate cell.

For example: at time T1, the network-side device sends a PDCCH order that indicates a new transmission and triggers the early acquisition of the TA value of candidate cell #1, and the terminal misses this PDCCH order;
at time T2, the network-side device sends the first PDCCH order that indicates a retransmission and triggers the early acquisition of the TA value of candidate cell #1.

That is, the first PDCCH order received by the terminal in the serving cell indicates a retransmission. In this case, the preamble received target power ramping counter is reset or not increased.

Alternatively,
after the terminal completes contention-based random access (CBRA) in the serving cell, the first PDCCH order received indicates a retransmission. In this case, the preamble received target power ramping counter is reset.

Solution 8: The latest PDCCH order used for random access and received by the terminal before the first PDCCH order is received is a legacy PDCCH order for triggering random access (legacy PDCCH order for Random Access).

It should be noted that the solutions described above may be implemented alone or in combination with each other.

Through the method provided in this embodiment, after the terminal misses a PDCCH order indicating an initial transmission, the PREAMBLE_POWER_RAMPING_COUNTER can still be set to 1, thereby avoiding that the terminal transmits the preamble with unnecessarily high power due to an excessively large value of the PREAMBLE_POWER_RAMPING_COUNTER.

### Embodiment 3

This embodiment mainly describes that after a terminal completes one early TA acquisition procedure of a candidate cell, a network side can trigger the terminal to execute early TA acquisition procedures of other candidate cells, or trigger the terminal to execute other random access procedures. Specifically, the following steps are included.

Steps 1 and 2 are the same as those in Embodiment 1.

Step 3: The source gNB sends a PDCCH order to the terminal at a second time to trigger the terminal to execute an early TA acquisition procedure of candidate cell #2 (C-cell#2); where
the second time may be before or after the source gNB acquires the TA value of C-cell#1, and the second time is any one of the following times:
a time when the source gNB successfully sends the PDCCH order that triggers the terminal to execute the early TA acquisition procedure of candidate cell C-cell#1; and
a time after a fourth duration has elapsed since successful sending of the PDCCH order by the source gNB, where the fourth duration may be any one of the following:
fixed; and
a variable duration determined based on different candidate cells, or measurement report of the terminal, or a capability of the terminal, or a location of the terminal, for example, including any one of the following:
different fourth durations corresponding to Intra-DU and Inter-DU;
different fourth durations corresponding to different candidate cells;
different fourth durations corresponding to different frequencies;
different fourth durations corresponding to different frequency bands;
different fourth durations corresponding to different terminals; and
different fourth durations corresponding to different terminal types

The unit of the fourth duration may be second, millisecond, microsecond, frame, subframe, slot, or symbol.

The method provided in this embodiment avoids the need to complete acquiring of the TA value of one candidate cell before proceeding to acquire the TA values of other candidate cells, thereby reducing the delay in obtaining the TA values of more candidate cells.

### Embodiment 4

In this embodiment, the terminal maintains a plurality of preamble received target power ramping counters (PREAMBLE_POWER_RAMPING_COUNTER), where each preamble received target power ramping counter is specific to any one of the following:
a serving cell;
one candidate cell; and
one group of candidate cells; where
one group of candidate cells may be any one of the following:
any several candidate cells allocated by the NW;
candidate cells belonging to a same DU or CU;
candidate cells belonging to a same frequency; and
candidate cells belonging to a same frequency band.

That is, the terminal maintains one preamble received target power ramping counter for the serving cell and one preamble received target power ramping counter for each candidate cell (or each group of candidate cells).

If the terminal maintains one preamble received target power ramping counter for each serving cell and one preamble received target power ramping counter for each candidate cell, when the terminal receives a PDCCH order indicating an initial transmission, the terminal sets the PREAMBLE_POWER_RAMPING_COUNTER associated with the candidate cell identifier (or candidate configuration identifier) carried in the PDCCH order to 1; when the PDCCH order indicates a retransmission, the terminal increments by 1 the PREAMBLE_POWER_RAMPING_COUNTER associated with the candidate cell identifier (or candidate configuration identifier) carried in the PDCCH order.

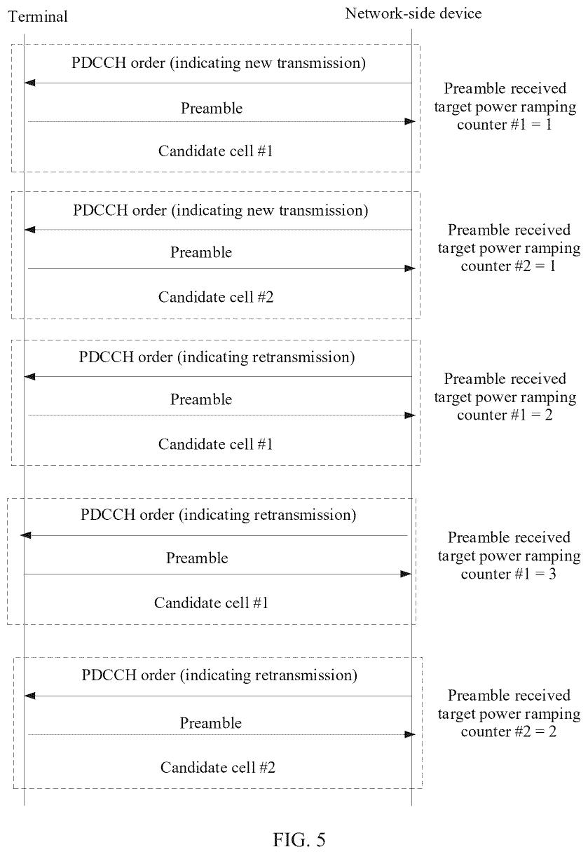

If the terminal maintains one preamble received target power ramping counter for each serving cell and one preamble received target power ramping counter for each group of candidate cells, the PDCCH order carries a first identifier, where the first identifier may be a group identifier, or a DU identifier, or a CU identifier, or a frequency identifier, or a frequency band identifier, each first identifier is associated with one group of cells, where the group of cells is a set of cells sharing one PREAMBLE_POWER_RAMPING_COUNTER, and an association relationship between the first identifier and the one group of cells may be agreed in a protocol or configured by the NW. In this case, in the network-side implementation in Embodiment 3, the source gNB cannot simultaneously trigger the terminal to execute the procedures of early acquisition of TAs of a plurality of cells in one group of cells. Specifically, the source gNB can trigger, only after obtaining a TA value of cell A in the group of cells, the terminal to execute the procedures of early acquisition of the TA values of other candidate cells excluding cell A in the group. On the terminal side, when the terminal receives a PDCCH order, if the PDCCH order indicates an initial transmission, the terminal sets the PREAMBLE_POWER_RAMPING_COUNTER associated with the first identifier carried in the PDCCH order to 1; if the PDCCH order indicates a retransmission, the terminal increments by 1 the PREAMBLE_POWER_RAMPING_COUNTER associated with the first identifier carried in the PDCCH order, as specifically shown in FIG. 5.

### Embodiment 5

This embodiment mainly describes the method for setting the plurality of preamble received target power ramping counters (PREAMBLE_POWER_RAMPING_COUNTER) described in Embodiment 4. Details are as follows.

In a case that a first condition is satisfied, the terminal resets a first PREAMBLE_POWER_RAMPING_COUNTER to 1, where the first PREAMBLE_POWER_RAMPING_COUNTER is a PREAMBLE_POWER_RAMPING_COUNTER associated with one candidate cell or one group of candidate cells. The first condition includes any one of the following:
a fifth timer expires;
a fifth duration exceeds a fifth threshold;
the terminal performs cell handover;
the terminal receives a PDCCH order carrying an identifier of a candidate cell or candidate cell group associated with a fifth timer or a fifth threshold and indicating a new transmission (initial transmission);
the terminal receives a PDCCH order carrying an identifier of a candidate cell or candidate cell group associated with a fifth timer or a fifth threshold and indicating a retransmission, but the terminal determines that it has missed a PDCCH order associated with the PDCCH order that indicates a new transmission (initial transmission); and
a second counter is greater than a sixth threshold.

Each candidate cell or candidate cell group is associated with one fifth timer which is used to indicate that the network side triggers the early TA acquisition procedure of a candidate cell associated with the fifth timer only before the fifth timer expires, or indicate that the terminal executes the early TA acquisition procedure of the candidate cell only before the fifth timer expires. The lengths of the fifth timer associated with the candidate cells or candidate cell groups may be the same or different, and may be configured by the network side or agreed in a protocol.

A start time of the fifth timer includes:
when the terminal receives a fourth PDCCH order that indicates a new transmission (initial transmission), where the fourth PDCCH order carries an identifier of the candidate cell or candidate cell group associated with the fifth timer; or
when the terminal receives a fifth PDCCH order that indicates a retransmission, where the fifth PDCCH order carries an identifier of the candidate cell or candidate cell group associated with the fifth timer, and the terminal determines that it has missed the PDCCH order associated with the fifth PDCCH order that indicates a new transmission (initial transmission).

The method for the terminal to determine that the PDCCH order associated with the fifth PDCCH order that indicates a retransmission is missed includes:
the terminal has not received any PDCCH order used to trigger the early acquisition of the TA value of the candidate cell before the fifth PDCCH order is received; and
the latest PDCCH order for RACH received by the terminal before the fifth PDCCH order is received is a legacy PDCCH order for RACH.

For the fifth duration exceeding a fifth threshold, each candidate cell or candidate cell group is associated with one fifth threshold which is used to indicate an upper limit of the duration for which the network side triggers the early TA acquisition procedure of the candidate cell associated with the fifth duration; or indicate an upper limit of the duration for which the terminal executes the early TA acquisition procedure to the candidate cell. The fifth thresholds associated with the candidate cells or candidate cell groups may be the same or different, and may be configured by the network side or agreed in a protocol.

A start time of the fifth duration may be the start time of the fifth timer.

For the second counter being greater than a sixth threshold, each candidate cell or candidate cell group is associated with one second counter and one sixth threshold, which are used to indicate a total number of times and an upper limit of times that the network side triggers the early TA acquisition procedure of a candidate cell associated with the counter and threshold; or indicate the number of times and an upper limit of times that the terminal executes the early TA acquisition procedure of the candidate cell. The sixth thresholds associated with the candidate cells or candidate cell groups may be the same or different, and may be configured by the network side or agreed in a protocol.

The condition for resetting the second counter, that is, setting it to 1 or 0, includes at least one of the following:
the terminal receives a PDCCH order carrying an identifier of a candidate cell or candidate cell group associated with the second counter and indicating a new transmission;
the terminal receives a PDCCH order carrying an identifier of a candidate cell or candidate cell group associated with the second counter and indicating a retransmission, and the terminal determines that the associated PDCCH order indicating a new transmission is missed.

If the terminal receives a PDCCH order carrying an identifier of a candidate cell or candidate cell group associated with the second counter and indicating a retransmission, and whether the associated PDCCH order indicating a new transmission is missed cannot be determined through this PDCCH order, the second counter is incremented by 1.

The embodiments of this application can be implemented as follows.

The network side triggers, through a PDCCH order, the terminal to execute an early TA acquisition procedure of a candidate cell, including:
Mode 1: after the source gNB completes (including successfully completing or unsuccessfully completing) the early TA acquisition procedure of C-cell#1, the source gNB can trigger the terminal to execute the early TA acquisition procedures of other candidate cells excluding C-cell#1; otherwise, it is not allowed to trigger the terminal to execute the early TA acquisition procedures of other candidate cells excluding C-cell#1; and
Mode 2: before the source gNB has not completed the early TA acquisition procedure of C-cell#1, the source gNB can trigger the terminal to execute the early TA acquisition procedures of other candidate cells excluding C-cell#1.

After the terminal receives a PDCCH order that is used to trigger the terminal to execute the early TA acquisition procedure of the candidate cell and indicates a retransmission, when some conditions are satisfied, the terminal sets the current PREAMBLE_POWER_RAMPING_COUNTER to 1.

The terminal maintains one preamble received target power ramping counter for the serving cell and one preamble received target power ramping counter for each candidate cell or each group of candidate cells.

It should be noted that the method provided in the embodiments of this application is applied to a case that the terminal has not received a notification for suspending the power ramping counter, that is, it is assumed that the terminal has not received a notification for suspending the power ramping counter.

Through the method provided in the embodiments of this application, the terminal can more accurately set the preamble received target power ramping counter, making it possible to transmit the preamble with appropriate preamble transmitting power. This can reduce energy consumption of the terminal as much as possible without reducing the probability of successfully acquiring the TA value of the candidate cell, thereby improving the transmitting performance of the terminal for transmitting the preamble.

The power ramping counter processing method provided in the embodiments of this application may be executed by a power ramping counter processing apparatus. In the embodiments of this application, the power ramping counter processing apparatus executing the power ramping counter processing method is used as an example to describe a power ramping counter processing apparatus according to an embodiment of this application.

The command sending method provided in the embodiments of this application may be executed by a command sending apparatus. In the embodiments of this application, the command sending apparatus executing the command sending method is used as an example to describe a command sending apparatus according to an embodiment of this application.

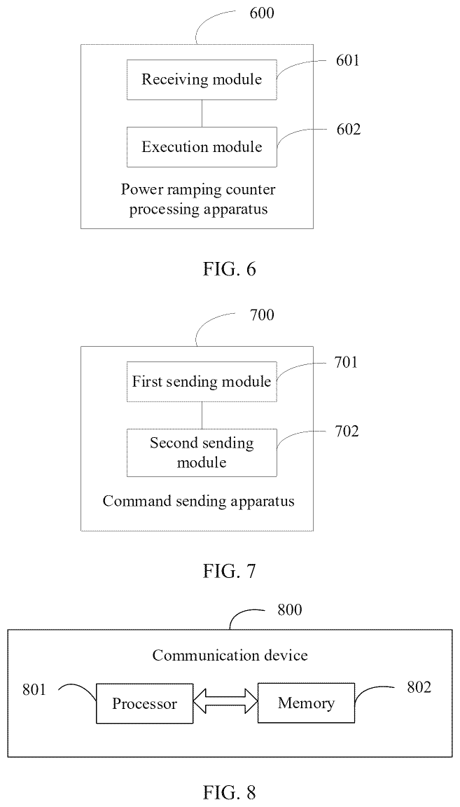

Referring to FIG. 6, FIG. 6 is a structural diagram of a power ramping counter processing apparatus according to an embodiment of this application. As shown in FIG. 6, the power ramping counter processing apparatus 600 includes:
a receiving module 601 configured to receive a target physical downlink control channel PDCCH order, where the target PDCCH order is used to trigger the terminal to execute an early TA acquisition procedure of a target candidate cell; and
an execution module 602 configured to perform a first operation, where the first operation includes at least one of the following:
in a case that the terminal maintains a plurality of preamble received target power ramping counters, resetting or incrementing by 1, based on the target PDCCH order, a preamble received target power ramping counter associated with the target candidate cell; and
resetting or incrementing by 1, based on target information, a preamble received target power ramping counter, where the target information includes at least one of the following:
an association relationship between the target PDCCH order and another PDCCH order;
association information of the another PDCCH order;
detection information associated with the target PDCCH order; and
an association relationship between the early TA acquisition procedure of the target candidate cell and a last random access procedure; where
the another PDCCH order includes a PDCCH order received before the target PDCCH order is received; and the last random access procedure is a latest random access procedure executed before the early TA acquisition procedure of the target candidate cell is executed.

Optionally, in a case that the target information satisfies a first condition, the preamble received target power ramping counter is reset; or
in a case that the target information satisfies a second condition, the preamble received target power ramping counter is incremented by 1; where
the first condition and the second condition are different conditions.

Optionally, the association relationship between the target PDCCH order and another PDCCH order includes at least one of the following:
a relationship between candidate cell information indicated by the target PDCCH order and candidate cell information indicated by the another PDCCH order; and
a time relationship between the target PDCCH order and the another PDCCH order.

Optionally, the first condition includes at least one of the following:
the candidate cell information indicated by the target PDCCH order is different from the candidate cell information indicated by the another PDCCH order;
a reception time difference between the target PDCCH order and the another PDCCH order is greater than or equal to a first threshold; and
the target PDCCH order is received after a timer corresponding to the another PDCCH order expires.

Optionally, the second condition includes at least one of the following:
the candidate cell information indicated by the target PDCCH order is the same as the candidate cell information indicated by the another PDCCH order;
a reception time difference between the target PDCCH order and the another PDCCH order is less than or equal to a first threshold; and
the target PDCCH order is received before a timer corresponding to the another PDCCH order expires.

Optionally, a start or restart time of the timer corresponding to the another PDCCH order includes at least one of the following:
a time when the terminal receives the another PDCCH order; and
a delayed time after the time when the terminal receives the another PDCCH order.

Optionally, the first threshold is associated with at least one of the following:
a handover type, a candidate cell, a frequency, a frequency band, the terminal, and a type of the terminal; or
a duration of the timer corresponding to the another PDCCH order is associated with at least one of the following:
a handover type, a candidate cell, a frequency, a frequency band, the terminal, and a type of the terminal; where
the handover type includes at least one of the following:
intra-distributed unit DU handover, inter-DU handover, intra-centralized unit CU handover, and inter-CU handover.

Optionally, the association information of the another PDCCH order includes:
a signal quality of a serving cell associated with the another PDCCH order upon receiving of the another PDCCH order; and
a type of the another PDCCH order; or
the detection information associated with the target PDCCH order includes:
whether a beam failure occurs before the target PDCCH order is received;
a signal quality of a serving cell associated with the target PDCCH order; and
whether a PDCCH order used to trigger the early acquisition of a TA of a candidate cell is received before the target PDCCH order is received.

Optionally, the signal quality of the serving cell associated with the target PDCCH order includes at least one of the following:
a signal quality of the serving cell associated with the target PDCCH order when the target PDCCH order is received; and
a signal quality of the serving cell associated with the target PDCCH order before the target PDCCH order is received.

Optionally, the first condition includes at least one of the following:
the signal quality of the serving cell associated with the another PDCCH order is lower than or equal to a second threshold;
the another PDCCH order is the latest PDCCH order received by the terminal before the target PDCCH order is received, and the type of the another PDCCH order is a PDCCH order used to trigger the terminal to execute a normal random access procedure;
a beam failure occurs before the target PDCCH order is received;
the signal quality of the serving cell associated with the target PDCCH order is lower than or equal to a third threshold; and
no PDCCH order used to trigger the early acquisition of a TA of a candidate cell is received before the target PDCCH order is received.

Optionally, the another PDCCH order includes:
a PDCCH order that is most recently received before the target PDCCH order is received, is used to trigger the terminal to execute the early TA acquisition procedure of the candidate cell, and indicates a new transmission; or
a PDCCH order that is most recently received before the target PDCCH order is received and is used to trigger the terminal to execute the early TA acquisition procedure of the candidate cell.

Optionally, the first condition includes at least one of the following:
the early TA acquisition procedure of the target candidate cell and the last random access procedure are associated with different cells; and
the last random access procedure does not exist.

Optionally, the second condition includes:
the early TA acquisition procedure of the target candidate cell and the last random access procedure are associated with a same cell; and
the target PDCCH order indicates a retransmission.

Optionally, the association relationship between the early TA acquisition procedure of the target candidate cell and the last random access procedure includes at least one of the following:
an association relationship between a cell associated with the early TA acquisition procedure of the target candidate cell and a cell associated with the last random access procedure; and
whether the last random access procedure exists before the early TA acquisition procedure of the target candidate cell is performed.

Optionally, the plurality of preamble received target power ramping counters include at least one of the following:
a preamble received target power ramping counter associated with the serving cell;
a preamble received target power ramping counter associated with a plurality of candidate cells; and
a preamble received target power ramping counter associated with a plurality of candidate cell groups.

Optionally, under a third condition, the preamble received target power ramping counter associated with the target candidate cell is reset, or a preamble received target power ramping counter associated with a candidate cell group to which the target candidate cell belongs is reset; where
the third condition includes at least one of the following:
a target timer expires, where the target timer includes a timer associated with the target candidate cell, or a timer associated with the candidate cell group to which the target candidate cell belongs;
a reception time difference between the target PDCCH order and a PDCCH order associated with the target PDCCH order that indicates a new transmission is greater than or equal to a fourth threshold;
the terminal performs cell handover;
a counter is greater than a fifth threshold, where the counter includes a counter associated with the target candidate cell, or a counter associated with the candidate cell group to which the target candidate cell belongs; and
the target PDCCH order indicates a new transmission; or the target PDCCH order indicates a retransmission, where the terminal has not received a PDCCH order associated with the target PDCCH order that indicates a new transmission before the target PDCCH order that indicates a retransmission is received.

Optionally, a start or restart time of the target timer includes:
a reception time of the PDCCH order associated with the target PDCCH order that indicates a new transmission; or
a reception time of the PDCCH order associated with the target PDCCH order that indicates a retransmission, where the terminal has not received the PDCCH order associated with the target PDCCH order that indicates a new transmission before the target PDCCH order that indicates a retransmission is received.

Optionally, the counter is reset in the following case:
at a reception time of the target PDCCH order that indicates a new transmission; or
at a reception time of the target PDCCH order that indicates a retransmission, where the terminal has not received the PDCCH order associated with the target PDCCH order that indicates a new transmission before the target PDCCH order that indicates a retransmission is received.

The foregoing power ramping counter processing apparatus can improve the transmitting performance of the terminal for transmitting the preamble.

In the embodiments of this application, the power ramping counter processing apparatus may be an electronic device, for example, an electronic device having an operating system, or may be a component in an electronic device, such as an integrated circuit or a chip. For example, the electronic device may be a terminal, or may be another device different from a terminal. By way of example, the terminal may include but is not limited to the types of terminals listed in the above embodiments, and the another device may be a server, a network attached storage (NAS), or the like, which are not specifically limited in the embodiments of this application.

The power ramping counter processing apparatus provided in the embodiment of this application can implement each process implemented by the method embodiment shown in FIG. 2 and achieve the same technical effect. To avoid repetition, details are not described herein again.

Referring to FIG. 7, FIG. 7 is a structural diagram of a command sending apparatus according to an embodiment of this application. As shown in FIG. 7, the command sending apparatus 700 includes:
a first sending module 701 configured to send a first physical downlink control channel PDCCH order to a terminal, where the first PDCCH order is used to trigger execution of an early TA acquisition procedure of a first candidate cell and indicate a new transmission; and
a second sending module 702 configured to send a second PDCCH order to the terminal under a target condition, where the second PDCCH order is used to trigger execution of an early TA acquisition procedure of a second candidate cell; and
the target condition includes any one of the following:
a network-side device confirms that the early TA acquisition procedure of the first candidate cell is completed successfully, or the network-side device confirms that the early TA acquisition procedure of the first candidate cell is not completed successfully;
the network-side device successfully sends the first PDCCH order; and
the network-side device successfully triggers the terminal to execute the early TA acquisition procedure of the first candidate cell.

Optionally, before a first timer expires, the network-side device acquires the TA of the first candidate cell and determines that the early TA acquisition procedure of the first candidate cell is completed successfully; and
the apparatus further includes:
a third sending module configured to, after the first timer expires, if the network-side device has not acquired the TA of the first candidate cell, send a third PDCCH order to the terminal, where the third PDCCH order is used to trigger execution of the early TA acquisition procedure of the first candidate cell and indicate a retransmission; where
a start or restart time of the first timer includes:
a time when the network-side device sends the first PDCCH order; and
a delayed time after the time when the network-side device sends the first PDCCH order.

Optionally, in a first case, the network-side device acquires the TA of the first candidate cell and determines that the early TA acquisition procedure of the first candidate cell is completed successfully; or
in a second case, the network-side device has not acquired the TA of the first candidate cell and confirms that the early TA acquisition procedure of the first candidate cell is not completed successfully; where
the first case includes that the first timer has not expired, and further includes at least one of the following:
a counter is less than or equal to a threshold, and a second timer has not expired; and
the second case includes at least one of the following:
a counter is greater than a threshold, and a second timer expires.

The counter is incremented by 1 when the network-side device sends the third PDCCH order; and
a start or restart time of the second timer includes:
a time when the network-side device triggers for the first time the terminal to execute the early TA acquisition procedure of the first candidate cell; or
a time when the successful completion of the early TA acquisition procedure of the first candidate cell is determined.

Optionally, the sending a second PDCCH order to the terminal under a target condition includes:
sending the second PDCCH order to the terminal at a time when the terminal is successfully triggered to execute the early TA acquisition procedure of the first candidate cell; or
sending the second PDCCH order to the terminal at a delayed time after the time when the first PDCCH order is successfully sent.

Optionally, the first candidate cell and the second candidate cell belong to different candidate cell groups.

The foregoing command sending apparatus can improve the transmitting performance of the terminal for transmitting the preamble.

The command sending apparatus in the embodiments of this application may be an electronic device, for example, an electronic device having an operating system, or may be a component in an electronic device, such as an integrated circuit or a chip. The electronic device may be a terminal or a network-side device.

The command sending apparatus provided in the embodiments of this application can implement each process implemented by the method embodiment shown in FIG. 3 and achieve the same technical effect. To avoid repetition, details are not described herein again.

Optionally, as shown in FIG. 8, an embodiment of this application further provides a communication device 800 including a processor 801 and a memory 802, where the memory 802 stores a program or instructions capable of running on the processor 801. For example, in a case that the communication device 800 is a first device, when the program or instructions are executed by the processor 801, the steps of the foregoing power ramping counter processing method embodiment are implemented, with the same technical effect achieved. To avoid repetition, details are not described herein again.

An embodiment of this application further provides a communication device including a processor and a communication interface. The communication interface is configured to receive a target PDCCH order, where the target PDCCH order is used to trigger the terminal to execute an early TA acquisition procedure of a target candidate cell. The processor is configured to perform a first operation, where the first operation includes at least one of the following: in a case that the terminal maintains a plurality of preamble received target power ramping counters, resetting or incrementing by 1, based on the target PDCCH order, a preamble received target power ramping counter associated with the target candidate cell; resetting or incrementing by 1, based on target information, a preamble received target power ramping counter, where the target information includes at least one of the following: an association relationship between the target PDCCH order and another PDCCH order; association information of the another PDCCH order; detection information associated with the target PDCCH order; and an association relationship between the early TA acquisition procedure of the target candidate cell and a last random access procedure; where the another PDCCH order includes a PDCCH order received before the target PDCCH order is received; and the last random access procedure is a latest random access procedure executed before the early timing advance acquisition procedure of the target candidate cell is executed. This communication device embodiment corresponds to the foregoing power ramping counter processing method embodiment, and each implementation process and implementation of the foregoing method embodiment can be applied to this communication device embodiment, with the same technical effect achieved.

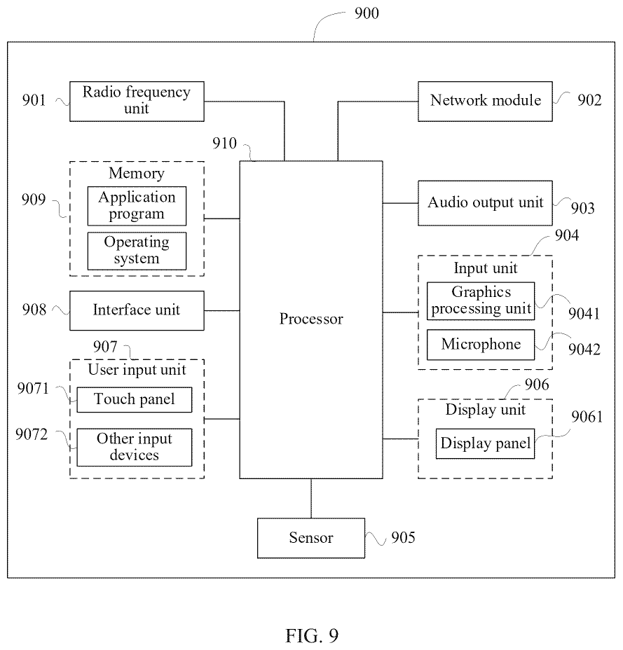

Specifically, FIG. 9 is a schematic diagram of a hardware structure of a terminal implementing an embodiment of this application.

The terminal 900 includes but is not limited to at least some of components such as a radio frequency unit 901, a network module 902, an audio output unit 903, an input unit 904, a sensor 905, a display unit 906, a user input unit 907, an interface unit 908, a memory 909, and a processor 910.

Persons skilled in the art can understand that the terminal 900 may further include a power supply (for example, a battery) supplying power to the components, and the power supply may be logically connected to the processor 910 through a power management system, so as to implement functions such as charging management, discharging management, and power consumption management by using the power management system. The structure of the terminal shown in FIG. 9 does not constitute any limitation on the terminal. The terminal may include more or fewer components than shown in the figure, or a combination of some components, or the components disposed differently. Details are not described herein.

It should be understood that in the embodiments of this application, the input unit 904 may include a graphics processing unit (GPU) 9041 and a microphone 9042. The graphics processing unit 9041 processes image data of a still picture or video obtained by an image capture apparatus (such as a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and other input devices 9072. The touch panel 9071 is also referred to as a touchscreen. The touch panel 9071 may include two parts: a touch detection apparatus and a touch controller. The other input devices 9072 may include but are not limited to a physical keyboard, a function key (such as a volume control key or an on/off key), a trackball, a mouse, and a joystick. Details are not described herein.

In the embodiments of this application, after receiving downlink data from the network-side device, the radio frequency unit 901 can transmit the downlink data to the processor 910 for processing. In addition, the radio frequency unit 901 can send uplink data to the network-side device. Typically, the radio frequency unit 901 includes but is not limited to an antenna, an amplifier, a transceiver, a coupler, a low noise amplifier, and a duplexer.

The memory 909 may be configured to store a software program or instructions and various data. The memory 909 may mainly include a first storage area for storing programs or instructions and a second storage area for storing data. The first storage area may store an operating system, an application program or instructions required by at least one function (for example, a sound play function or an image play function), and the like. Additionally, the memory 909 may include a volatile memory or a non-volatile memory, or the memory 909 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), or a direct rambus random access memory (DRRAM). The memory 909 in the embodiment of this application includes but is not limited to these and any other suitable types of memory.

The processor 910 may include one or more processing units. Optionally, the processor 910 integrates an application processor and a modem processor. The application processor primarily processes operations involving an operating system, a user interface, an application program, or the like. The modem processor, such as a baseband processor, primarily processes radio communication signals. It can be understood that the modem processor may alternatively be not integrated into the processor 910.

The radio frequency unit 901 is configured to receive a target physical downlink control channel PDCCH order, where the target PDCCH order is used to trigger the terminal to execute an early TA acquisition procedure of a target candidate cell.

The processor 910 is configured to perform a first operation, where the first operation includes at least one of the following:
in a case that the terminal maintains a plurality of preamble received target power ramping counters, resetting or incrementing by 1, based on the target PDCCH order, a preamble received target power ramping counter associated with the target candidate cell; and
resetting or incrementing by 1, based on target information, a preamble received target power ramping counter, where the target information includes at least one of the following:
an association relationship between the target PDCCH order and another PDCCH order;
association information of the another PDCCH order;
detection information associated with the target PDCCH order; and
an association relationship between the early TA acquisition procedure of the target candidate cell and a last random access procedure; where
the another PDCCH order includes a PDCCH order received before the target PDCCH order is received; and the last random access procedure is a latest random access procedure executed before the early timing advance acquisition procedure of the target candidate cell is executed.

Optionally, in a case that the target information satisfies a first condition, the preamble received target power ramping counter is reset; or
in a case that the target information satisfies a second condition, the preamble received target power ramping counter is incremented by 1; where
the first condition and the second condition are different conditions.

Optionally, the association relationship between the target PDCCH order and another PDCCH order includes at least one of the following:
a relationship between candidate cell information indicated by the target PDCCH order and candidate cell information indicated by the another PDCCH order; and
a time relationship between the target PDCCH order and the another PDCCH order.

Optionally, the first condition includes at least one of the following:
the candidate cell information indicated by the target PDCCH order is different from the candidate cell information indicated by the another PDCCH order;
a reception time difference between the target PDCCH order and the another PDCCH order is greater than or equal to a first threshold; and
the target PDCCH order is received after a timer corresponding to the another PDCCH order expires.

Optionally, the second condition includes at least one of the following:
the candidate cell information indicated by the target PDCCH order is the same as the candidate cell information indicated by the another PDCCH order;
a reception time difference between the target PDCCH order and the another PDCCH order is less than or equal to a first threshold; and
the target PDCCH order is received before a timer corresponding to the another PDCCH order expires.

Optionally, a start or restart time of the timer corresponding to the another PDCCH order includes at least one of the following:
a time when the terminal receives the another PDCCH order; and
a delayed time after the time when the terminal receives the another PDCCH order.

Optionally, the first threshold is associated with at least one of the following:
a handover type, a candidate cell, a frequency, a frequency band, the terminal, and a type of the terminal; or
a duration of the timer corresponding to the another PDCCH order is associated with at least one of the following:
a handover type, a candidate cell, a frequency, a frequency band, the terminal, and a type of the terminal; where
the handover type includes at least one of the following:
intra-distributed unit DU handover, inter-DU handover, intra-centralized unit CU handover, and inter-CU handover.

Optionally, the association information of the another PDCCH order includes:
a signal quality of a serving cell associated with the another PDCCH order upon receiving of the another PDCCH order; and
a type of the another PDCCH order; or
the detection information associated with the target PDCCH order includes:
whether a beam failure occurs before the target PDCCH order is received;
a signal quality of a serving cell associated with the target PDCCH order; and
whether a PDCCH order used to trigger the early acquisition of a TA of a candidate cell is received before the target PDCCH order is received.

Optionally, the signal quality of the serving cell associated with the target PDCCH order includes at least one of the following:
a signal quality of the serving cell associated with the target PDCCH order when the target PDCCH order is received; and
a signal quality of the serving cell associated with the target PDCCH order before the target PDCCH order is received.

Optionally, the first condition includes at least one of the following:
the signal quality of the serving cell associated with the another PDCCH order is lower than or equal to a second threshold;
the another PDCCH order is the latest PDCCH order received by the terminal before the target PDCCH order is received, and the type of the another PDCCH order is a PDCCH order used to trigger the terminal to execute a normal random access procedure;
a beam failure occurs before the target PDCCH order is received;
the signal quality of the serving cell associated with the target PDCCH order is lower than or equal to a third threshold; and
no PDCCH order used to trigger the early acquisition of a TA of a candidate cell is received before the target PDCCH order is received.

Optionally, the another PDCCH order includes:
a PDCCH order that is most recently received before the target PDCCH order is received, is used to trigger the terminal to execute the early TA acquisition procedure of the candidate cell, and indicates a new transmission; or
a PDCCH order that is most recently received before the target PDCCH order is received and is used to trigger the terminal to execute the early TA acquisition procedure of the candidate cell.

Optionally, the plurality of preamble received target power ramping counters include at least one of the following:
a preamble received target power ramping counter associated with the serving cell;
a preamble received target power ramping counter associated with a plurality of candidate cells; and
a preamble received target power ramping counter associated with a plurality of candidate cell groups.

Optionally, under a third condition, the preamble received target power ramping counter associated with the target candidate cell is reset, or a preamble received target power ramping counter associated with a candidate cell group to which the target candidate cell belongs is reset; where
the third condition includes at least one of the following:
a target timer expires, where the target timer includes a timer associated with the target candidate cell, or a timer associated with the candidate cell group to which the target candidate cell belongs;
a reception time difference between the target PDCCH order and a PDCCH order associated with the target PDCCH order that indicates a new transmission is greater than or equal to a fourth threshold;
the terminal performs cell handover;
a counter is greater than a fifth threshold, where the counter includes a counter associated with the target candidate cell, or a counter associated with the candidate cell group to which the target candidate cell belongs; and
the target PDCCH order indicates a new transmission; or the target PDCCH order indicates a retransmission, where the terminal has not received a PDCCH order associated with the target PDCCH order that indicates a new transmission before the target PDCCH order that indicates a retransmission is received.

Optionally, a start or restart time of the target timer includes:
a reception time of the PDCCH order associated with the target PDCCH order that indicates a new transmission; or
a reception time of the PDCCH order associated with the target PDCCH order that indicates a retransmission, where the terminal has not received the PDCCH order associated with the target PDCCH order that indicates a new transmission before the target PDCCH order that indicates a retransmission is received.

Optionally, the counter is reset in the following case:
at a reception time of the target PDCCH order that indicates a new transmission; or
at a reception time of the target PDCCH order that indicates a retransmission, where the terminal has not received the PDCCH order associated with the target PDCCH order that indicates a new transmission before the target PDCCH order that indicates a retransmission is received.

The foregoing terminal can improve the transmitting performance of the terminal for transmitting the preamble.

It can be understood that for the implementation processes of the various implementations mentioned in this embodiment, reference may be made to the relevant description in the foregoing power ramping counter processing method, and the same or corresponding technical effects can be achieved. To avoid repetition, details are not described herein again.

An embodiment of this application further provides a device including a processor and a communication interface, where the communication interface is coupled to the processor, and the processor is configured to run a program or instructions to implement each process of the method embodiment shown in FIG. 3. This device embodiment corresponds to the foregoing power ramping counter processing method embodiment, and each implementation process and implementation of the foregoing method embodiment can be applied to this device embodiment, with the same technical effect achieved.

An embodiment of this application further provides a device including a processor and a communication interface. The communication interface is configured to: send a first physical downlink control channel PDCCH order to a terminal, where the first PDCCH order is used to trigger execution of an early TA acquisition procedure of a first candidate cell and indicate a new transmission; and send a second PDCCH order to the terminal under a target condition, where the second PDCCH order is used to trigger execution of an early TA acquisition procedure of a second candidate cell; and the target condition includes any one of the following: a network-side device confirms that the early TA acquisition procedure of the first candidate cell is completed successfully, or the network-side device confirms that the early TA acquisition procedure of the first candidate cell is not completed successfully; the network-side device successfully sends the first PDCCH order; and the network-side device successfully triggers the terminal to execute the early TA acquisition procedure of the first candidate cell.

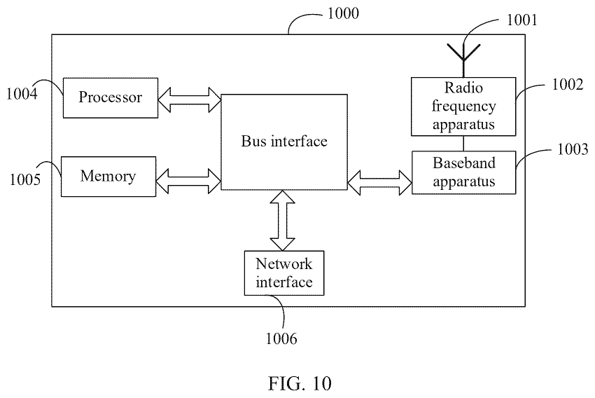

Specifically, an embodiment of this application further provides a network-side device. As shown in FIG. 10, the network-side device 1000 includes: an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information through the antenna 1001 and sends the received information to the baseband apparatus 1003 for processing. In a downlink direction, the baseband apparatus 1003 processes information to be sent and sends the information to the radio frequency apparatus 1002, and the radio frequency apparatus 1002 processes the received information and sends the information out via the antenna 1001.

The power ramping counter processing method in the above embodiments may be implemented in the baseband apparatus 1003, where the baseband apparatus 1003 includes a baseband processor.

The baseband apparatus 1003 may include, for example, at least one baseband processing unit, where a plurality of chips are disposed on the baseband processing unit. As shown in FIG. 10, one of the chips is, for example, the baseband processor, and connected to the memory 1005 via a bus interface, to invoke the program in the memory 1005 to perform the operations of the network-side device shown in the foregoing method embodiment.

The network-side device may further include a network interface 1006. The interface is, for example, a common public radio interface (CPRI).

Specifically, the network-side device 1000 in the embodiment of this application further includes: instructions or a program stored in the memory 1005 and capable of running on the processor 1004. The processor 1004 calls the instructions or program in the memory 1005 to execute the method executed by each module shown in FIG. 7, with the same technical effect achieved. To avoid repetition, details are not described herein again.

The radio frequency apparatus 1002 sends a first physical downlink control channel PDCCH order to a terminal, where the first PDCCH order is used to trigger execution of an early TA acquisition procedure of a first candidate cell and indicate a new transmission; and sends a second PDCCH order to the terminal under a target condition, where the second PDCCH order is used to trigger execution of an early TA acquisition procedure of a second candidate cell; and
the target condition includes any one of the following:
the network-side device confirms that the early TA acquisition procedure of the first candidate cell is completed successfully, or the network-side device confirms that the early TA acquisition procedure of the first candidate cell is not completed successfully;
the network-side device successfully sends the first PDCCH order; and
the network-side device successfully triggers the terminal to execute the early TA acquisition procedure of the first candidate cell.

Optionally, before a first timer expires, the network-side device acquires the TA of the first candidate cell and determines that the early TA acquisition procedure of the first candidate cell is completed successfully; and
the radio frequency apparatus 1002 is further configured to:
after the first timer expires, if the network-side device has not acquired the TA of the first candidate cell, send a third PDCCH order to the terminal, where the third PDCCH order is used to trigger execution of the early TA acquisition procedure of the first candidate cell and indicate a retransmission; where
a start or restart time of the first timer includes:
a time when the network-side device sends the first PDCCH order; and
a delayed time after the time when the network-side device sends the first PDCCH order.

Optionally, in a first case, the network-side device acquires the TA of the first candidate cell and determines that the early TA acquisition procedure of the first candidate cell is completed successfully; or
in a second case, the network-side device has not acquired the TA of the first candidate cell and confirms that the early TA acquisition procedure of the first candidate cell is not completed successfully; where
the first case includes that the first timer has not expired, and further includes at least one of the following:
a counter is less than or equal to a threshold, and a second timer has not expired; and
the second case includes at least one of the following:
a counter is greater than a threshold, and a second timer expires.

The counter is incremented by 1 when the network-side device sends the third PDCCH order; and
a start or restart time of the second timer includes:
a time when the network-side device triggers for the first time the terminal to execute the early TA acquisition procedure of the first candidate cell; or
a time when the successful completion of the early TA acquisition procedure of the first candidate cell is determined.

Optionally, the sending a second PDCCH order to the terminal under a target condition includes:
sending the second PDCCH order to the terminal at a time when the terminal is successfully triggered to execute the early TA acquisition procedure of the first candidate cell; or
sending the second PDCCH order to the terminal at a delayed time after the time when the first PDCCH order is successfully sent.

Optionally, the first candidate cell and the second candidate cell belong to different candidate cell groups.

The foregoing network-side device can improve the random access performance of the terminal.

It can be understood that for the implementation processes of the various implementations mentioned in this embodiment, reference may be made to the relevant description in the foregoing method embodiment, and the same or corresponding technical effects can be achieved. To avoid repetition, details are not described herein again.

An embodiment of this application further provides a readable storage medium, where a program or instructions are stored on the readable storage medium, and when the program or instructions are executed by a processor, each process of the embodiments of the foregoing power ramping counter processing method or command sending method is implemented, with the same technical effect achieved. To avoid repetition, details are not described herein again.

The processor is the processor in the terminal described in the foregoing embodiment. The readable storage medium includes a computer-readable storage medium, such as a computer read-only memory ROM, a random access memory RAM, a magnetic disk, or a compact disc. In some examples, the readable storage medium may be a non-volatile readable storage medium.

An embodiment of this application further provides a chip, where the chip includes a processor and a communication interface, the communication interface is coupled to the processor, and the processor is configured to run a program or instructions to implement each process of the embodiments of the foregoing power ramping counter processing method or command sending method, and with the same technical effect achieved. To avoid repetition, details are not described herein again.

It should be understood that the chip mentioned in this embodiment of this application may also be referred to as a system-level chip, a system chip, a chip system, a system-on-chip, or the like.

An embodiment of this application further provides a computer program/program product, where the computer program/program product is stored in a storage medium, and the computer program/program product is executed by at least one processor to implement each process of the embodiments of the foregoing power ramping counter processing method or command sending method, with the same technical effect achieved. To avoid repetition, details are not described herein again.

An embodiment of this application further provides a wireless communication system including: a terminal and a network-side device, where the terminal may be configured to perform the steps of the power ramping counter processing method according to the embodiments of this application, and the network-side device may be configured to perform the steps of the command sending method according to the embodiments of this application.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiment may be implemented by a computer software product with a necessary general hardware platform. Certainly, the method in the foregoing embodiment may also be implemented by hardware. The computer software product is stored in a storage medium (such as a ROM, a RAM, a magnetic disk, or a compact disc), and includes several instructions for instructing a terminal or a network-side device to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive.

What is claimed is:

1. A power ramping counter processing method, comprising:
receiving, by a terminal, a target physical downlink control channel (PDCCH) order, wherein the target PDCCH order is used to trigger the terminal to execute an early timing advance (TA) acquisition procedure of a target candidate cell; and
performing, by the terminal, a first operation, wherein the first operation comprises at least one of the following:
in a case that the terminal maintains a plurality of preamble received target power ramping counters, resetting or incrementing by 1, based on the target PDCCH order, a preamble received target power ramping counter associated with the target candidate cell; or
resetting or incrementing by 1, based on target information, a preamble received target power ramping counter, wherein the target information comprises at least one of the following:
an association relationship between the target PDCCH order and another PDCCH order;
association information of the another PDCCH order;
detection information associated with the target PDCCH order; or
an association relationship between the early TA acquisition procedure of the target candidate cell and a last random access procedure; wherein
the another PDCCH order comprises a PDCCH order received before the target PDCCH order is received; and
the last random access procedure is a latest random access procedure executed before the early TA acquisition procedure of the target candidate cell is executed.

2. The method according to claim 1, wherein in a case that the target information satisfies a first condition, the preamble received target power ramping counter is reset; or
in a case that the target information satisfies a second condition, the preamble received target power ramping counter is incremented by 1; wherein
the first condition and the second condition are different conditions.

3. The method according to claim 1, wherein the association relationship between the target PDCCH order and another PDCCH order comprises at least one of the following:
a relationship between candidate cell information indicated by the target PDCCH order and candidate cell information indicated by the another PDCCH order; or
a time relationship between the target PDCCH order and the another PDCCH order.

4. The method according to claim 2, wherein the first condition comprises at least one of the following:
the candidate cell information indicated by the target PDCCH order is different from the candidate cell information indicated by the another PDCCH order;
a reception time difference between the target PDCCH order and the another PDCCH order is greater than or equal to a first threshold; or
the target PDCCH order is received after a timer corresponding to the another PDCCH order expires.

5. The method according to claim 2, wherein the second condition comprises at least one of the following:
the candidate cell information indicated by the target PDCCH order is the same as the candidate cell information indicated by the another PDCCH order;
a reception time difference between the target PDCCH order and the another PDCCH order is less than or equal to a first threshold; or
the target PDCCH order is received before a timer corresponding to the another PDCCH order expires.

6. The method according to claim 4, wherein a start or restart time of the timer corresponding to the another PDCCH order comprises at least one of the following:
a time when the terminal receives the another PDCCH order; or
a delayed time after the time when the terminal receives the another PDCCH order.

7. The method according to claim 4, wherein the first threshold is associated with at least one of the following:
a handover type, a candidate cell, a frequency, a frequency band, the terminal, or a type of the terminal; or
a duration of the timer corresponding to the another PDCCH order is associated with at least one of the following:
a handover type, a candidate cell, a frequency, a frequency band, the terminal, or a type of the terminal; wherein
the handover type comprises at least one of the following:
intra-distributed unit (DU) handover, inter-DU handover, intra-centralized unit (CU) handover, or inter-CU handover.

8. The method according to claim 1, wherein the association information of the another PDCCH order comprises:
a signal quality of a serving cell associated with the another PDCCH order upon receiving of the another PDCCH order; and
a type of the another PDCCH order; or
the detection information associated with the target PDCCH order comprises:
whether a beam failure occurs before the target PDCCH order is received;
a signal quality of a serving cell associated with the target PDCCH order; and
whether a PDCCH order used to trigger the early acquisition of a TA of a candidate cell is received before the target PDCCH order is received;
wherein the signal quality of the serving cell associated with the target PDCCH order comprises at least one of the following:
a signal quality of the serving cell associated with the target PDCCH order when the target PDCCH order is received; or
a signal quality of the serving cell associated with the target PDCCH order before the target PDCCH order is received.

9. The method according to claim 2, wherein the first condition comprises at least one of the following:
the signal quality of the serving cell associated with the another PDCCH order is lower than or equal to a second threshold;
the another PDCCH order is the latest PDCCH order received by the terminal before the target PDCCH order is received, and the type of the another PDCCH order is a PDCCH order used to trigger the terminal to execute a normal random access procedure;
a beam failure occurs before the target PDCCH order is received;
the signal quality of the serving cell associated with the target PDCCH order is lower than or equal to a third threshold; or
no PDCCH order used to trigger the early acquisition of a TA of a candidate cell is received before the target PDCCH order is received.

10. The method according to claim 1, wherein the another PDCCH order comprises:
a PDCCH order that is most recently received before the target PDCCH order is received, is used to trigger the terminal to execute the early TA acquisition procedure of the candidate cell, and indicates a new transmission; or
a PDCCH order that is most recently received before the target PDCCH order is received and is used to trigger the terminal to execute the early TA acquisition procedure of the candidate cell.

11. The method according to claim 2, wherein the first condition comprises at least one of the following:
the early TA acquisition procedure of the target candidate cell and the last random access procedure are associated with different cells; or
the last random access procedure does not exist.

12. The method according to claim 2, wherein the second condition comprises:
the early TA acquisition procedure of the target candidate cell and the last random access procedure are associated with a same cell; and
the target PDCCH order indicates a retransmission.

13. The method according to claim 1, wherein the association relationship between the early TA acquisition procedure of the target candidate cell and the last random access procedure comprises at least one of the following:
an association relationship between a cell associated with the early TA acquisition procedure of the target candidate cell and a cell associated with the last random access procedure; or
whether the last random access procedure exists before the early TA acquisition procedure of the target candidate cell is performed.

14. The method according to claim 1, wherein the plurality of preamble received target power ramping counters comprise at least one of the following:
a preamble received target power ramping counter associated with the serving cell;
a preamble received target power ramping counter associated with a plurality of candidate cells; or
a preamble received target power ramping counter associated with a plurality of candidate cell groups.

15. A command sending method, comprising:
sending, by a network-side device, a first physical downlink control channel (PDCCH) order to a terminal, wherein the first PDCCH order is used to trigger execution of an early timing advance (TA) acquisition procedure of a first candidate cell and indicate a new transmission; and
sending, by the network-side device, a second PDCCH order to the terminal under a target condition, wherein the second PDCCH order is used to trigger execution of an early TA acquisition procedure of a second candidate cell; and
the target condition comprises any one of the following:
the network-side device confirms that the early TA acquisition procedure of the first candidate cell is completed successfully, or the network-side device confirms that the early TA acquisition procedure of the first candidate cell is not completed successfully;
the network-side device successfully sends the first PDCCH order; or
the network-side device successfully triggers the terminal to execute the early TA acquisition procedure of the first candidate cell.

16. The method according to claim 15, wherein before a first timer expires, the network-side device acquires the TA of the first candidate cell and determines that the early TA acquisition procedure of the first candidate cell is completed successfully; and
the method further comprises:
after the first timer expires, if the network-side device has not acquired the TA of the first candidate cell, sending, by the network-side device, a third PDCCH order to the terminal, wherein the third PDCCH order is used to trigger execution of the early TA acquisition procedure of the first candidate cell and indicate a retransmission; wherein
a start or restart time of the first timer comprises:
a time when the network-side device sends the first PDCCH order; and
a delayed time after the time when the network-side device sends the first PDCCH order.

17. The method according to claim 16, wherein in a first case, the network-side device acquires the TA of the first candidate cell and determines that the early TA acquisition procedure of the first candidate cell is completed successfully; or
in a second case, the network-side device has not acquired the TA of the first candidate cell and confirms that the early TA acquisition procedure of the first candidate cell is not completed successfully; wherein
the first case comprises that the first timer has not expired, and further comprises at least one of the following:
a counter is less than or equal to a threshold, or a second timer has not expired; and
the second case comprises at least one of the following:
a counter is greater than a threshold, and a second timer expires; wherein
the counter is incremented by 1 when the network-side device sends the third PDCCH order; or
a start or restart time of the second timer comprises:
a time when the network-side device triggers for the first time the terminal to execute the early TA acquisition procedure of the first candidate cell; or
a time when the successful completion of the early TA acquisition procedure of the first candidate cell is determined;
wherein the sending, by the network-side device, a second PDCCH order to the terminal under a target condition comprises:
sending, by the network-side device, the second PDCCH order to the terminal at a time when the terminal is successfully triggered to execute the early TA acquisition procedure of the first candidate cell; or
sending, by the network-side device, the second PDCCH order to the terminal at a delayed time after the time when the first PDCCH order is successfully sent.

18. A terminal, comprising a processor and a memory, wherein the memory stores a program or instructions capable of running on the processor, wherein the program or instructions, when executed by the processor, cause the terminal to perform:
receiving a target physical downlink control channel (PDCCH) order, wherein the target PDCCH order is used to trigger the terminal to execute an early timing advance (TA) acquisition procedure of a target candidate cell; and
performing a first operation, wherein the first operation comprises at least one of the following:
in a case that the terminal maintains a plurality of preamble received target power ramping counters, resetting or incrementing by 1, based on the target PDCCH order, a preamble received target power ramping counter associated with the target candidate cell; or
resetting or incrementing by 1, based on target information, a preamble received target power ramping counter, wherein the target information comprises at least one of the following:
an association relationship between the target PDCCH order and another PDCCH order;
association information of the another PDCCH order;
detection information associated with the target PDCCH order; or
an association relationship between the early TA acquisition procedure of the target candidate cell and a last random access procedure; wherein
the another PDCCH order comprises a PDCCH order received before the target PDCCH order is received; and
the last random access procedure is a latest random access procedure executed before the early TA acquisition procedure of the target candidate cell is executed.

19. The terminal according to claim 18, wherein in a case that the target information satisfies a first condition, the preamble received target power ramping counter is reset; or
in a case that the target information satisfies a second condition, the preamble received target power ramping counter is incremented by 1; wherein
the first condition and the second condition are different conditions.

20. A network-side device, comprising a processor and a memory, wherein the memory stores a program or instructions capable of running on the processor, and when the program or instructions are executed by the processor, steps of the PDCCH order sending method according to claim 15 are implemented.
